(19) United States
(12) Patent Application Publication
(10) Pub. No.: US 2013/0270809 A1
(43) Pub. Date: Oct. 17, 2013

(54) ALBUMS HAVING VARIABLE WIDTH SPINES AND THE COMPONENTS THEREOF

(71) Applicant: Hans Johann Horn, Bern (CH)

(72) Inventor: Hans Johann Horn, Bern (CH)

(21) Appl. No.: 13/828,660

(22) Filed: Mar. 14, 2013

Related U.S. Application Data
(63) Continuation-in-part of application No. 13/108,675, filed on May 16, 2011.
(60) Provisional application No. 61/334,938, filed on May 14, 2010.

(51) Int. Cl. B42D 1/08

(52) U.S. Cl. CPC B42D 1/08
USPC 281/28

(57) ABSTRACT

Albums having variable width spines and the components thereof are described. An example album includes a first cover, a second cover, a first spine element includes a first side and a second side. The first side includes a plurality of first extensions, a first rib, and a first groove. The second side is coupled to the first cover. A second spine element includes a third side and a fourth side. The third side includes a plurality of third openings, a third rib, and a third groove. The fourth side is coupled to the second cover. To couple the first spine element to the second spine element, the first rib is received by the third groove, the third rib is received by the first groove and, as the spine elements are longitudinally moved relative to one another, the first extensions are received within a portion of the respective third openings.

This patent arises from a continuation-in-part of U.S. application Ser. No. 13/108,675 filed on May 16, 2011, which claims priority to U.S. Provisional Application No. 61/334,938 filed May 14, 2010, both of which are are hereby incorporated herein by reference in their entirety.

### FIELD OF THE DISCLOSURE

This patent relates generally to albums and, more specifically, to albums having variable width spines and the components thereof.

### BACKGROUND

Known albums are available having variable content, in which album sheets can be inserted or removed. Some known albums are able to increase their size as additional album sheets are inserted into the album. Specifically, some known albums (e.g., post albums) are provided with extendable screws and variable-length bushing inserts onto which perforated album sheets may be affixed or hung. Different length extendable screws and/or bushings are utilized depending on the number of additional album sheets that are to be added. Thus, the width of the album spine can grow as pages are inserted. However, depending on the number of album sheets that are added once the additional extendable screw(s) and/or bushing(s) is/are added to these known albums, the album sheets may be loose within the album. Additionally, known albums must telescopically grow to enable the album to properly close once a certain number of additional album sheets have been added and, thus, lateral edges of known album spines may be slightly inverted relative to the album.

Other known albums are provided with adjustable string-on straps arranged on and extending across the album spine or the album cover. Generally, these string-on straps telescopically extend as content or pages are added to the album. These string-on straps may not be esthetically pleasing and, thus, adjustable covering devices are typically added. Additionally, the album sheets must be removed from the strap to rearrange the order of the album sheets within the album. Specifically, to remove, rearrange and/or insert album sheets within the string-on strap album and/or the post album, all of the album sheets have to be individually removed from the strap or the extendable screws and/or bushings to insert an album sheet in a particular location within either of these albums. Thus, the holes of the album sheets have a tendency to tear.

### BRIEF DESCRIPTION OF THE DRAWINGS

FIGS. 1 and 2 depict different views of an example album including a plurality of spine elements.

FIG. 3 depicts example album covers separated from the plurality of spine elements.

FIG. 4 depicts an example first spine element separated from an example second spine element, the second spine element having an example retaining bar attached thereto.

FIG. 5 depicts the first spine element, the second spine element and the retaining bar removed from the second spine element.

FIG. 6 depicts a detailed view of one of the pegs of the second spine element of FIG. 5.

FIG. 7 depicts a detailed view of an example rib and groove of the example first spine element of FIG. 5.

FIG. 8 depicts a detailed view of an example rib and groove of the example second spine element of FIG. 5.

FIG. 9 depicts a detailed view of a groove defined by the first spine element of FIG. 5.

FIG. 10 depicts a detailed view of an extension of the second spine element of FIG. 5.

FIG. 11 depicts an end of the first spine element of FIG. 5.

FIG. 12 depicts an end of the second spine element of FIG. 5.

FIG. 13 depicts ends of the first and second spine elements of FIG. 5.

FIG. 14 depicts ends of the first and second spine elements of FIG. 5 coupled together.

FIG. 15 depicts an example spine including a plurality of example spine elements.

FIG. 16 depicts an example interior of the example spine of FIG. 15.

FIG. 17 depicts a side of the example spine elements and sheets.

FIG. 18 depicts a cross-sectional view along R-R of FIG. 17.

FIG. 19 depicts a first side of an example spine element.

FIG. 20 depicts a second side of the example spine element of FIG. 19.

FIG. 21 depicts a different view of the first side of the example spine element of FIG. 19.

FIG. 22 depicts a cross-sectional view along A-A of FIG. 21.

FIG. 23 depicts a cross-sectional view along B-B of FIG. 21.

FIG. 24 depicts a cross-sectional view along C-C of FIG. 21.

FIG. 25 depicts a first end of the example spine element of FIG. 19.

FIG. 26 depicts a second end of the example spine element of FIG. 19.

FIG. 27 depicts a different view of the second side of the example spine element of FIG. 19.

FIG. 28 depicts a cross-sectional view along D-D of FIG. 27.

FIG. 29 depicts a top view of the example spine element of FIG. 19.

FIG. 30 depicts an exploded view of the example spine element of FIG. 19.

FIGS. 31 and 32 depict different views of an example first portion.

FIG. 33 depicts a different view of the first portion of the example spine element.

FIG. 34 depicts a cross-sectional view along G-G of FIG. 33.

FIG. 35 depicts a cross-sectional view along H-H of FIG. 33.

FIG. 36 depicts a cross-sectional view along I-I of FIG. 33.

FIG. 37 depicts a cross-sectional view along J-J of FIG. 33.

FIGS. 38-41 depict different views of example pegs.

FIG. 42 depicts a view of the first side of an example second portion.

FIG. 43 depicts a detailed view of a portion of FIG. 42.

FIG. 44 depicts a view of the second side of the example second portion.

FIG. 45 depicts a detailed view of a portion of FIG. 44.

FIG. 46 depicts a view of the first side of the example second portion.

FIG. 47 depicts a cross-sectional view along K-K of FIG. 46.

FIG. 48 depicts a cross-sectional view along L-L of FIG. 46.

FIG. 49 depicts a cross-sectional view along M-M of FIG. 46.

FIG. 50 depicts a cross-sectional view along N-N of FIG. 46.

FIGS. 51-54 depict various views of two of the example spine element in the process of being coupled together.

FIGS. 55-58 depict various views of two of the example spine elements in the process of being coupled together.

FIGS. 59-62 depict various views of two of the example spine elements coupled together.

FIG. 63 depicts an example retaining bar.

FIG. 64 depicts a partial view of one of the example spine elements.

FIG. 65 depicts a partial view of one of the example spine elements.

FIG. 66 depicts one of the example spine elements.

FIG. 67 depicts a cross-sectional view along S-S of FIG. 66.

FIG. 68 depicts two of the example spine elements in the process of being coupled together.

FIG. 69 depicts an example spine element.

FIGS. 70-73 depict different views of an example peg.

FIG. 74 depicts a partial view of an example second portion.

FIG. 75A depicts an example album in a closed position.

FIG. 75B depicts the example album of FIG. 75A in an open position.

FIG. 76 depicts a first spine element of the example album of FIG. 75A.

FIGS. 77-78 depict alternative isometric views of the first spine element of FIG. 76.

FIGS. 79-80 depict side views of the first spine element of FIGS. 76-78.

FIG. 81 depicts a second spine element of the example album of FIG. 75A.

FIGS. 82-83 depict alternative isometric views of the second spine element of FIG. 81.

FIGS. 84-85 depict side views of the second spine element of FIGS. 81-83.

FIG. 86A depicts example spine elements that can be used to implement the example binders disclosed herein.

FIG. 86B depicts an example binder in a closed position that includes the spine elements of FIG. 86A.

FIG. 86C depicts an example binder in a closed position that includes the spine elements of FIG. 86A.

FIGS. 87-88 depict alternative isometric views of the first spine element of FIGS. 86A-86C.

FIGS. 89-90 depict side views of the first spine element of FIGS. 86A-88.

FIG. 91-92 depicts alternative isometric views of the second spine element of FIGS. 86A-86C.

FIGS. 93-94 depict side views of the second spine element of FIGS. 86A-86C and 91-92.

### DETAILED DESCRIPTION

Certain examples are shown in the above-identified figures and described in detail below. In describing these examples, like or identical reference numbers are used to identify common or similar elements. The figures are not necessarily to scale and certain features and certain views of the figures may be shown exaggerated in scale or in schematic for clarity and/or conciseness. Additionally, several examples have been described throughout this specification. Any features from any example may be included with, a replacement for, or otherwise combined with other features from other examples.

The examples described herein relate to binders or albums that can be used in work related activities, recreational activities, etc., to conveniently store items or materials. The example albums described herein include a spine whose width can be customized and/or varied to suit a particular application or use. The spine may include a plurality of spine elements that may be detachably coupled to one another. Adding spine elements to the spine increases the width of the spine and enables additional content to be contained within the album. Removing spine elements from the spine decreases the width of the spine and enables less content to be contained within the album. In some examples, the order in which the spine elements are positioned within the spine may be rearranged to change the order in which content contained in the album is presented.

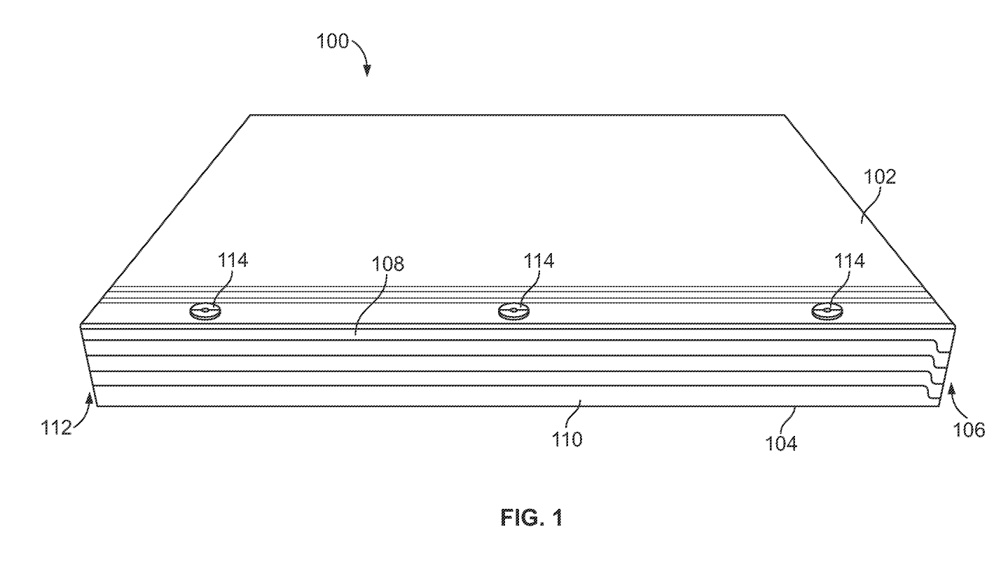

FIG. 1 depicts an example album or binder 100 that can be used for storing similar or different items or materials. In some examples, the items or materials may include documents, inserts, sleeves, photos, etc. In some examples, the items or materials may be of similar or different size, shape, thickness, etc.

The album 100 includes a first cover 102, a second cover 104 and a spine 106. In some examples, the spine 106 includes first and second partial spine elements 108 and 110 and a plurality of spine elements 112. The partial spine elements 108 and 110 may be different from one another and may be coupled to the respective cover 102 or 104 using fasteners 114 and/or adhesive, for example. However, in some examples, the partial spine elements 108 or 110 may be integral to the respective cover 102 or 104. The plurality of spine elements 112 may be substantially similar to one another.

In some examples, the partial spine elements 108 and 110 may be detachably or removably coupled to one of the plurality of spine elements 112 adjacent thereto. In some examples, the partial spine elements 108 and 110 may be detachably or removably coupled to one another such that the spine 106 is relatively small. The spine elements 112 may be detachably or removably coupled to one of the spine elements 112 adjacent thereto or, depending on the position of the respective spine element 112, to the first and/or second partial spine elements 108 or 110.

The size of the spine 106 may be changed to accommodate additional or less items or materials by changing the number of the spine elements 112 (e.g., 0, 1, 2, 3, 4, etc.) included in the spine 106. In some examples, the first partial spine element 108 may be detached from the spine element 112 adjacent thereto and then one or more of the spine elements 112 may be added to or removed from the plurality of spine elements 112. The first partial spine element 108 may then be reattached to the adjacent spine element 112 or, if no spine elements 112 are provided, to the second partial spine element 110. In some examples, the second partial spine element 110 may be detached from the spine element 112 adjacent thereto and then one or more of the spine elements 112 may be added to or removed from the plurality of spine elements 112. The second partial spine element 110 may then be reattached to the adjacent spine element 112 or, if no spine elements 112 are provided, to the first partial spine element 108.

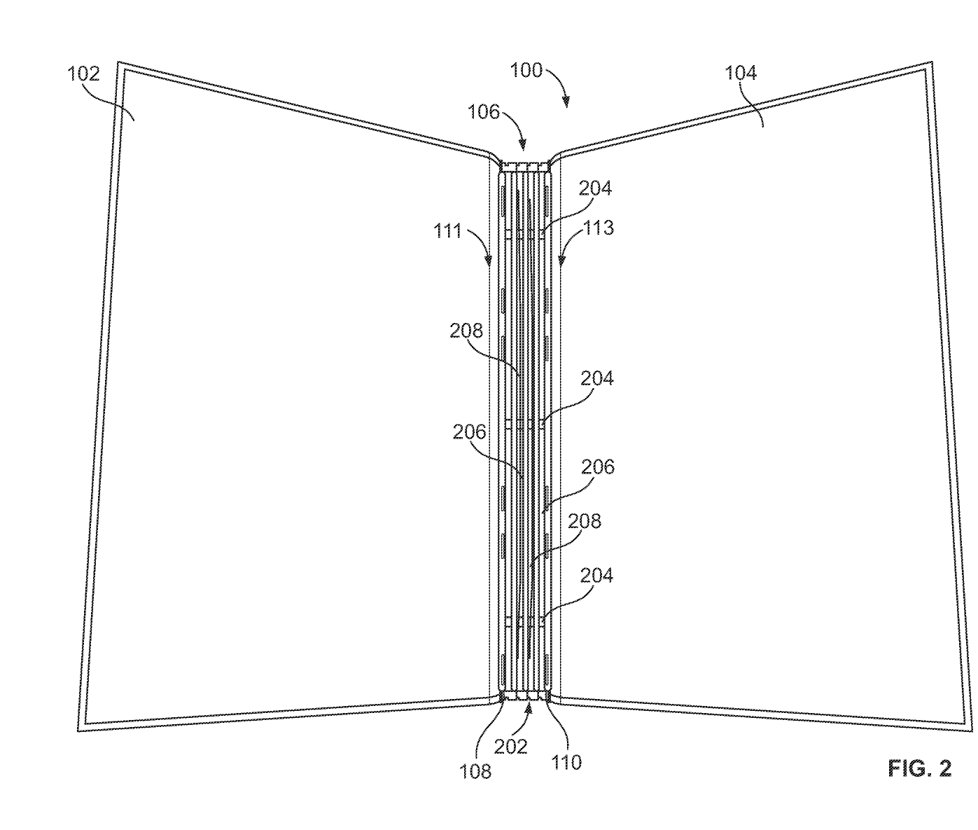

FIG. 2 depicts the album 100 having the covers 102 and 104 open illustrating an interior 202 of the spine 106. In some examples, to open the album, the covers 102, 104 are bent about hinges (e.g., living hinges) 111, 113 of the covers 102, 104. At least some of the spine elements 108, 110 and/or 112 include posts, extensions, pins or pegs 204. In some examples, the pegs 204 at least partially facilitate coupling with the adjacent spine element 112 and/or the partial spine element 108 and/or 110. In some examples, the pegs 204 facilitate the retaining of items and/or materials within the album 100. The items and/or materials may be positioned within a gap 206 that is defined between each of the spine elements 112 and/or the partial spine elements 108 and/or 110. The items or materials may be secured within the respective gap 206 via the pegs 204. In some examples, a retaining bar or compressor bar 208 is positioned within the gap 206. The retaining bar 208 may urge the items or materials within the gap 206 against one of the respective spine elements 112 and/or the partial spine elements 108 and/or 110. Thus, the items or materials may be substantially prevented from being loose within the gap 206 and the album 100. In some examples, the retaining bar 208 may be made of metal, plastic, etc. The retaining bar 208 may include a curvature that may slightly deform (e.g., elastically deform) when positioned in the gap 206. The deformation of the retaining bar 208 may bias the items or materials within the gap 206, for example.

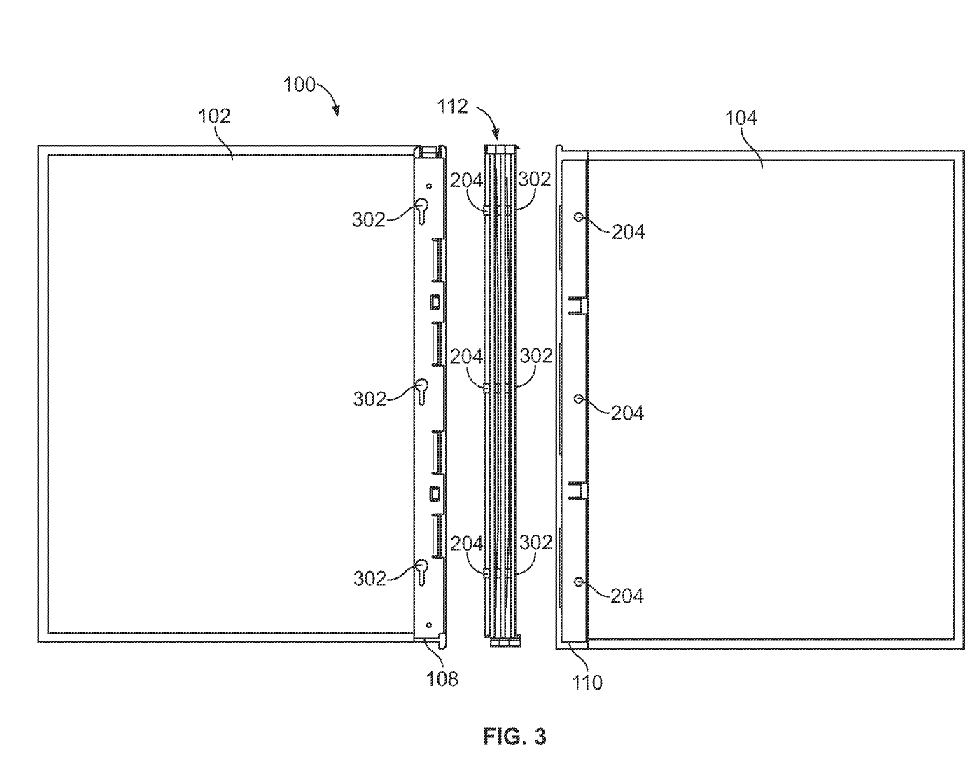

FIG. 3 depicts the album 100 in which the partial spine elements 108 and 110 and, thus, the covers 102 and 104 are detached from the spine elements 112. In some examples, the first partial element 108 defines recesses or openings 302 that interact with the pegs 204 to at least partially facilitate coupling with the adjacent spine element 112 and/or the second partial spine element 110.

The spine elements 112 may define the openings 302 substantially opposite or adjacent to the pegs 204 of the same spine element 112. The openings 302 of the spine elements 112 interact with the pegs 204 of another spine element 112 and/or the second partial spine element 110 to at least partially facilitate coupling with the adjacent spine element 112 and/or the second partial spine element 110, for example. In some examples, the second partial spine element 110 includes the pegs 204 that interact with the openings 302 of the adjacent spine element 112 and/or the first partial spine element 108 to at least partially facilitate coupling therewith.

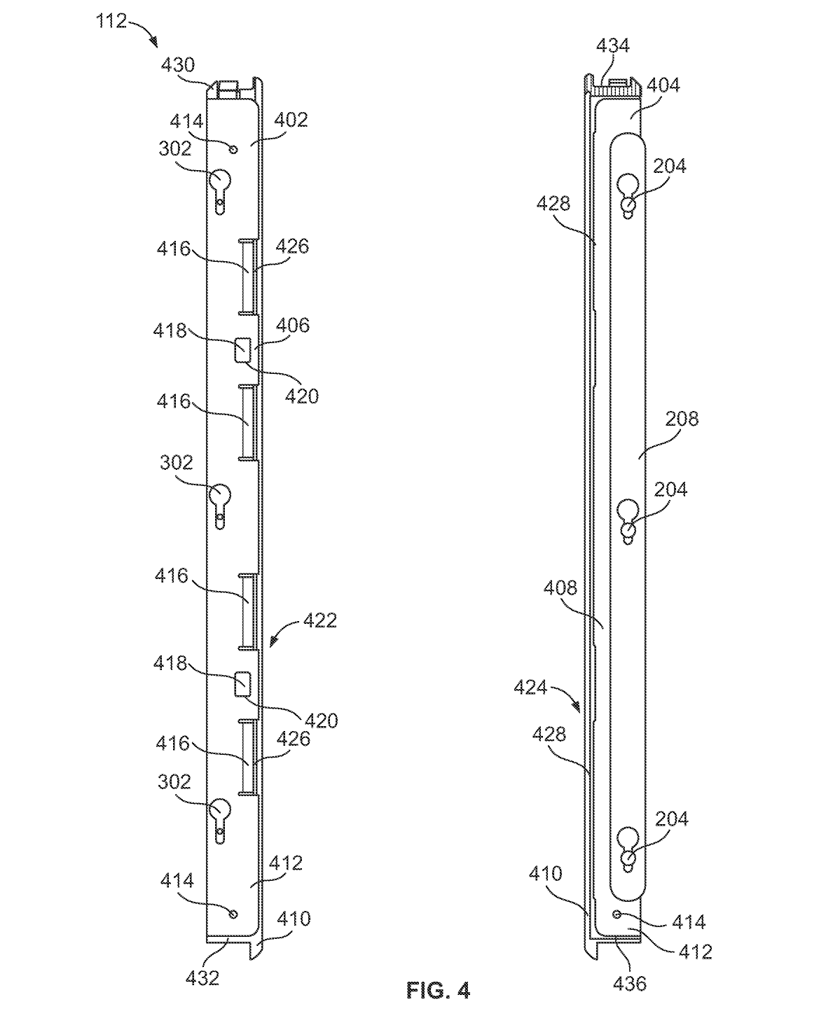

FIG. 4 depicts first and second spine elements 402 and 404 that are detached from one another. A first side 406 of the first spine element 402 is depicted and a second side 408 of the second spine element 404 is depicted. In some examples, the first spine element 402 may have a second side opposite the first side 406 that is similar to the second side 408 of the second spine element 404. In some examples, the second spine element 404 may have a first side opposite the second side 408 that is similar to the first side 406 of the first spine element 402. Thus, the first and second spine elements 402 and 404 may be substantially similar to one another. The first side 406 may be substantially similar to the first partial spine element 108 and the second side 408 may be substantially similar to the second partial spine element 110, for example.

In some examples, the first spine element 402 and/or the second spine element 404 may include a first portion 410 made of a plastic material and a second portion 412 made of a metal material. The first portion 410 may be coupled to the second portion 412 using fasteners 414 and/or by pre-tensioning the second portion 412 prior to coupling with the first portion 410, for example. The first portion 410 may be coupled to the second portion 412 by providing the second portion 412 with tabs 416 that interact with the first portion 410 and/or by providing the first portion 410 with tabs 418 that interact with openings 420 defined by the second portion 412, for example.

As described in more detail below, the spine elements and/or the partial spine elements may include one or more features that enable coupling with and/or stability relative to the adjacent spine element and/or partial spine element(s). In some examples, the first side 406 includes the openings 302 that interact with the pegs 204 of the second side 408 to at least partially facilitate coupling with and/or stability relative to the second spine element 404. In some examples, the first side 406 includes a groove and rib 422 that interacts with a corresponding groove and rib 424 of the second side 408 to at least partially facilitate coupling with and/or stability relative to the second spine element 404. In some examples, the first side 406 defines a groove 426 that interacts with an extension 428 of the second side 408 to at least partially facilitate coupling with and/or stability relative to the second spine element 404. In some examples, ends 430 and 432 of the first side 406 interact with respective ends 434 and 436 of the second side 408 to at least partially facilitate coupling with and/or stability relative to the second spine element 404.

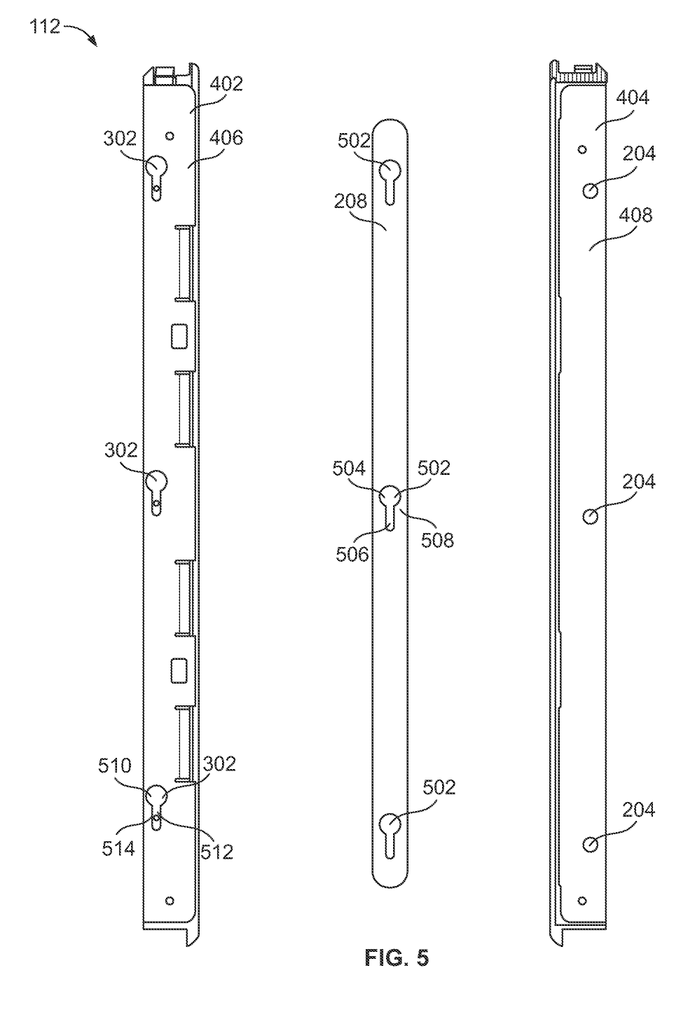

FIG. 5 depicts the first and second spine elements 402 and 404 with the retaining bar 208 removed from the second spine element 404. The retaining bar 208 defines openings or apertures 502 that interact with the pegs 204 to secure the retaining bar 208 relative to the second spine element 404. In some examples, the apertures 502 may include a first portion 504 and a second portion 506 that is a different size and/or shape than the first portion 504. The first portion 504 enables the respective peg 204 to be positioned through the aperture 502. After the retaining bar 208 is moved relative to the pegs 204, a surface 508 adjacent the second portion 506 interacts with the respective peg 204 to secure the retaining bar 208 relative to the second spine element 404, for example.

In some examples, the openings 302 may include a first portion 510 and a second portion 512 that is a different size and/or shape than the first portion 510. The first portion 510 enables the respective peg 204 to be positioned through the opening 302. After the spine elements 402 and 404 are moved relative to one another, an interior surface or lip 514 adjacent the second portion 512 interacts with the respective peg 204 to at least partially facilitate coupling with and/or stability relative to the second spine element 404.

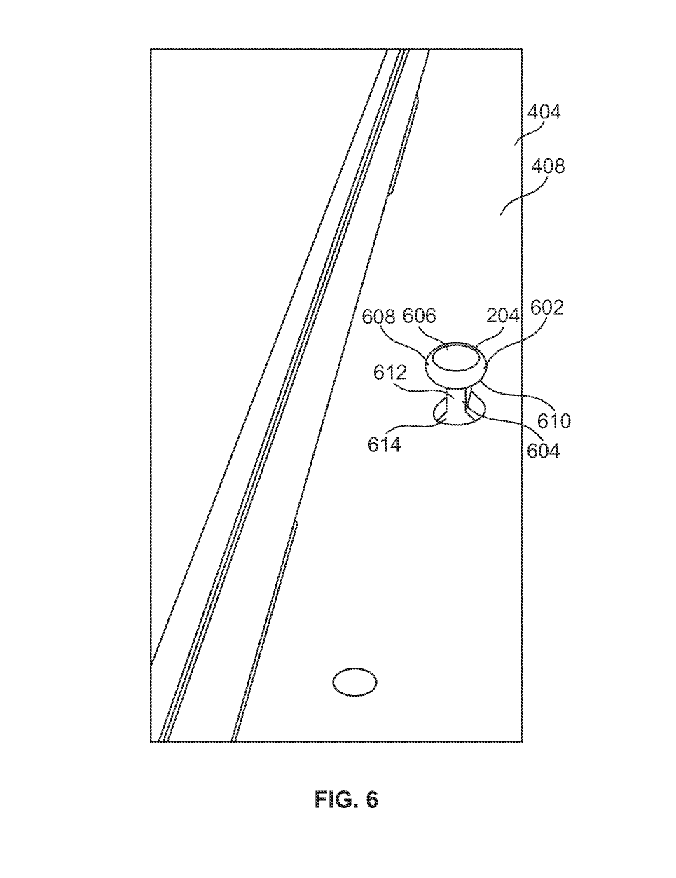

FIG. 6 depicts a detailed view of one of the pegs 204 on the second side 408 of the second spine element 404. The peg 204 may include a head 602 and a central portion 604 coupled to and/or integral with the second side 408.

In some examples, the head 602 may have a substantially flat top surface 606 and/or may include a tapered surface 608 that substantially surrounds a perimeter of the head 602. The head 602 may be sized to be positioned through the first portion 510 (FIG. 5) of the opening 302 (FIG. 5) and/or the first portion 504 (FIG. 5) of the aperture 502 (FIG. 5). In some examples, the head 602 may include a substantially flat bottom surface 610 opposite the top surface 606. Once positioned in the second portion 514, the bottom surface 610 may interact with the interior surface 514 (FIG. 5) to at least partially facilitate coupling with and/or stability relative to the first spine element 402 (FIG. 5).

The central portion 604 may be sized to be positioned substantially within the second portion 512 (FIG. 5) of the opening 302 (FIG. 5) and/or the second portion 506 (FIG. 5) of the aperture 502 (FIG. 5). In some examples, the central portion 604 may include a substantially rectangular portion 612 having an end coupled to the head 602 and a tapered portion 614 coupled between the rectangular portion 612 and the second side 408, for example.

In practice, the heads 602 of the pegs 204 may be inserted into the first portion 510 (FIG. 5) of the respective openings 302 (FIG. 5) until the bottom surface 610 is beneath the interior surface 514 (FIG. 5). The spine elements 402 and 404 (FIG. 5) may then be longitudinally moved relative to one another, thereby positioning the central portion 604 substantially within the second portion 512 (FIG. 5) and the bottom surface 610 adjacent to and/or engaging the interior surface 514 (FIG. 5). The interaction between the bottom surface 610 and the interior surface 514 (FIG. 5) substantially prevents the pegs 204 from being removed from the respective openings 302 (FIG. 5).

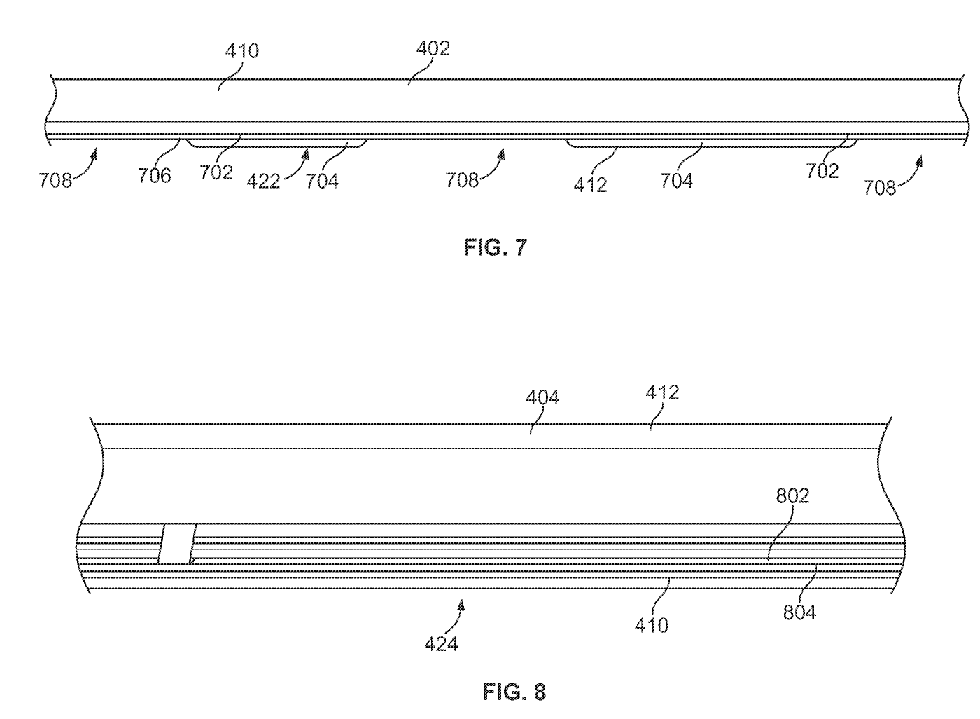

FIG. 7 depicts a detailed view of the groove and rib 422 of the first spine element 402. In some examples, the groove and rib 422 includes a groove 702 defined by the first portion 410 and/or the second portion 412. The portion of the groove 702 defined by the first portion 410 may be slightly curved or arch shaped; however, any other suitable shape may be used instead. In some examples, the groove and rib 422 includes a rib 704 of the second portion 412 that may slightly extend past an edge 706 of the first portion 410. The rib 704 may at least partially define the groove 702. In some examples, the second portion 412 may intermittently extend past the edge 706 and provide the rib 704. Thus, some sections 708 of the groove 702 may not be defined by the second portion 412.

FIG. 8 depicts a detailed view of the groove and rib 424 of the second spine element 404. In some examples, the groove and rib 424 includes a groove 802 defined by the first portion 410. In some examples, the groove and rib 424 includes a rib 804 that at least partially defines the groove 802.

Referring to FIGS. 7 and 8, in practice, the rib 704 is to be at least partially positioned within the groove 802 and the rib 804 is to be at least partially positioned in the groove 702. The interaction between the grooves and ribs 422 and 424 at least partially enables the spine elements 402 and 404 to be coupled together and/or relatively stable relative to one another, for example.

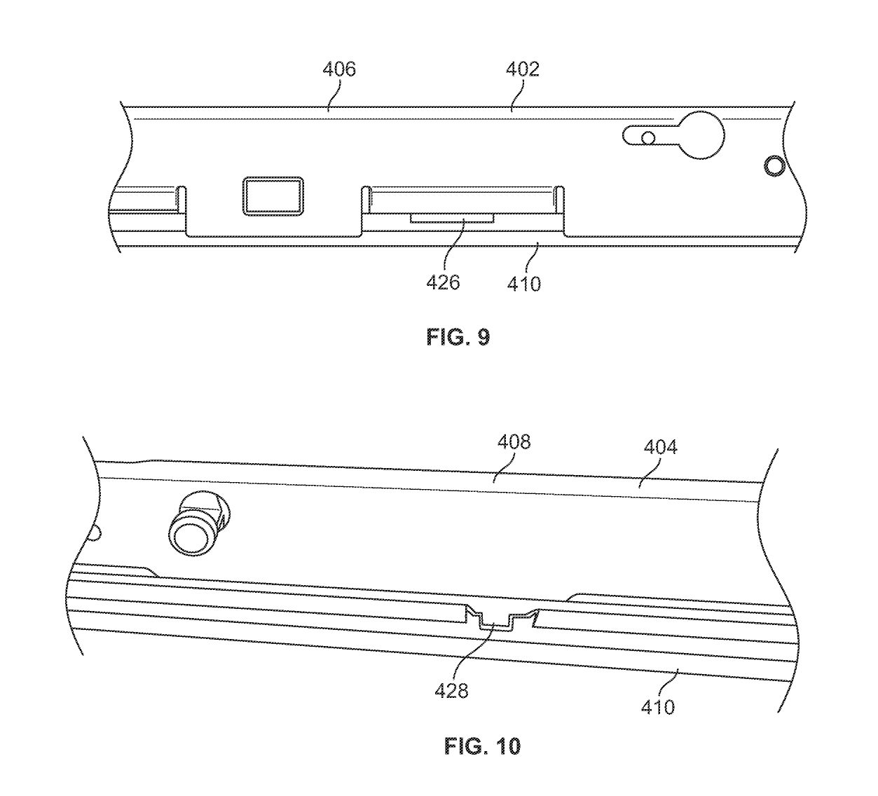

FIG. 9 depicts a detailed view of the groove 426 of the first spine element 402. In some examples, the groove 426 may be defined by the first portion 410.

FIG. 10 depicts a detailed view of the extension 428 of the second spine element 404. In some examples, the extension 428 may extend from the first portion 410. Referring to FIGS. 9 and 10, in practice, the extension 428 is to be at least partially positioned in the groove 426. The interaction between the extension 428 and the groove 426 at least partially enables the spine elements 402 and 404 to be relatively stable relative to one another, for example.

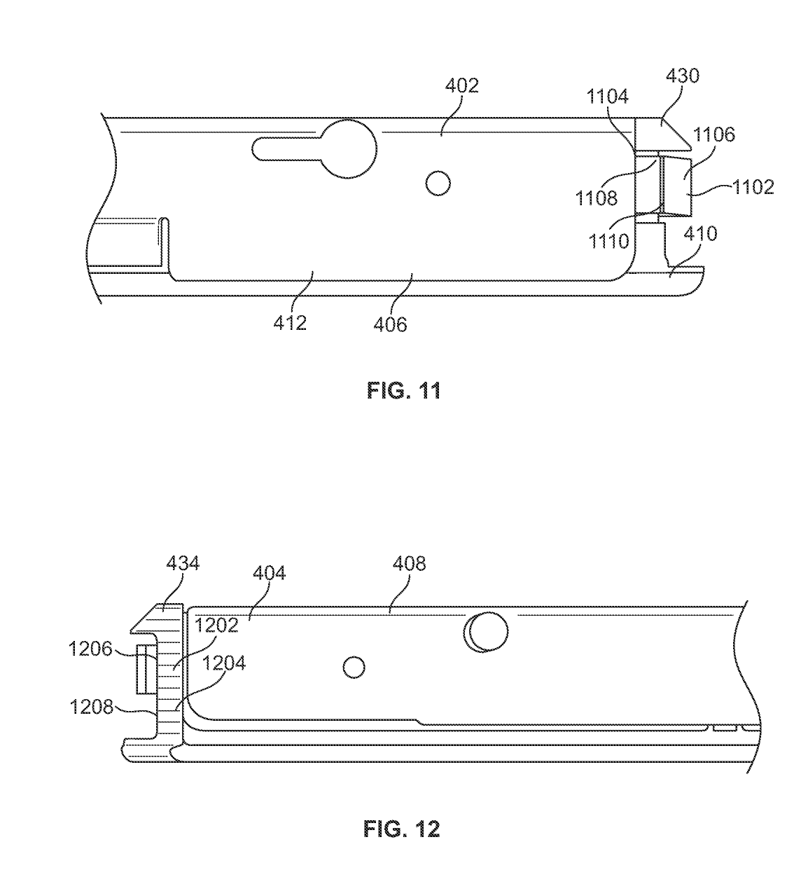

FIG. 11 depicts a detailed view of the end 430 of the first spine element 402. The end 430 includes a biasing or locking element or mechanism 1102. The locking element 1102 may be part of the first portion 410. In some examples, the locking element 1102 may be biased by a tab (not shown) formed from the second portion 412 and positioned beneath the locking element 1102. The interaction between the tab and the locking element 1102 may urge the locking element 1102 toward an edge 1104 of the second portion 412, for example. In some examples, the locking element 1102 includes a tapered surface 1106 and a step 1108 that may facilitate coupling with and/or stability relative to the second spine element 404.

FIG. 12 depicts a detailed view of the end 434 of the second spine element 404. The end 434 includes an extension or step 1202 having a first edge 1204, a second edge 1206 and a surface 1208. In some examples, the first edge 1204 may be adjacent to a tapered surface (not shown) that corresponds to the tapered surface 1106 of the locking element 1102. Referring to FIGS. 11 and 12, in practice, as the locking element 1102 is moved toward the step 1202, the tapered surface 1106 may engage the first edge 1204, which compresses the locking element 1102. The second spine element 404 may be further moved relative to the first spine element 402 until the step 1108 of the locking element 1102 is positioned adjacent to the second edge 1206. Once past the second edge 1206, the locking element 1102 may extend such that a surface 1110 of the locking element 1102 is positioned adjacent to the surface 1208. The interaction between the locking element 1102 and the step 1202 at least partially enables the spine elements 402 and 404 to be coupled and/or relatively stable relative to one another, for example.

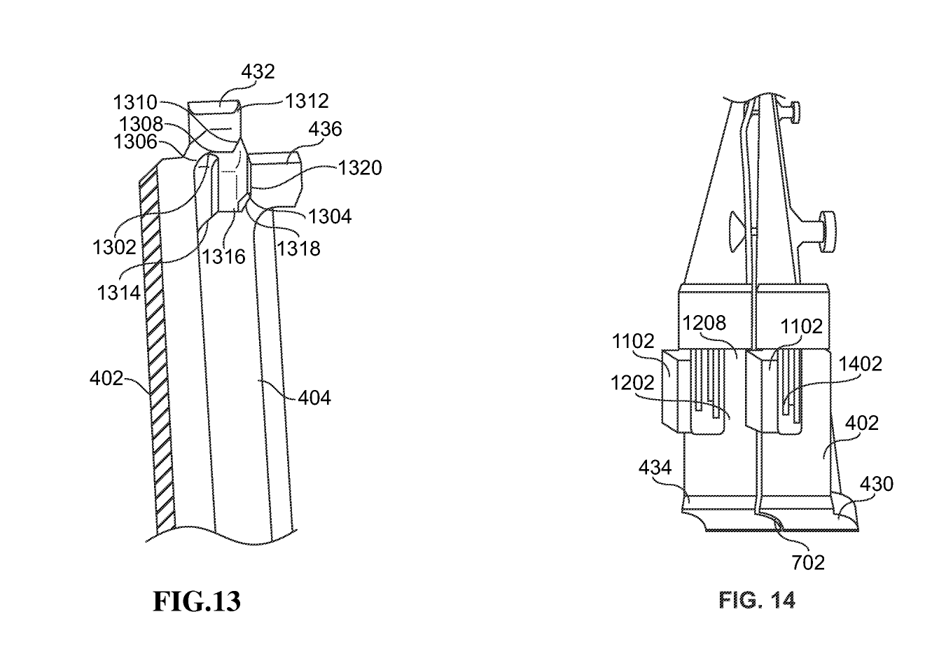

FIG. 13 depicts the ends 432 and 436 of the spine elements 402 and 404. The end 432 includes a step 1302 that corresponds to a notch 1304 defined by the end 436. In some examples, the step 1302 includes first thru fourth surfaces 1306-1312 that correspond to first thru fourth surfaces 1314-1320 of the notch 1304.

In practice, when the locking element 110 is secured relative to the step 1202, the step 1302 and the notch 1304 engage. The interaction between the step 1302 and the notch 1304 at least partially enables the spine elements 402 and 404 to be coupled and/or relatively stable relative to one another, for example.

FIG. 14 depicts the ends 430 and 434 of the first and second spine elements 402 and 404 coupled together. The locking element 1102 is positioned adjacent to the surface 1208 of the step 1202 to at least partially couple the first spine element 402 and the second spine element 404. In some examples, a tab or biasing element 1402 is positioned adjacent the locking element 1102 to urge the locking element 1102 into engagement with the surface 1208. In some examples, the portion of the groove 702 defined by the first spine element 402 may be a curved surface.

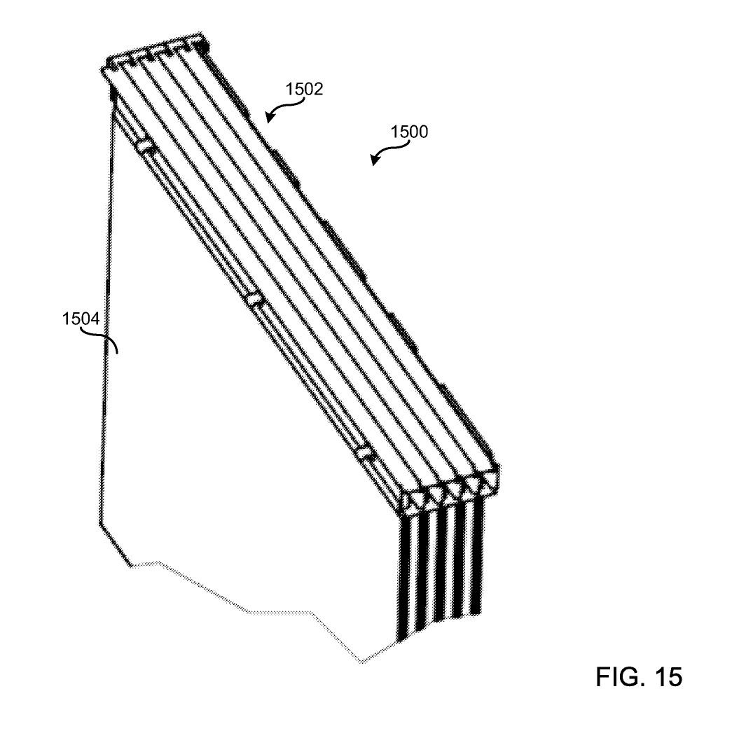

FIG. 15 depicts an example spine 1500 including a plurality of example spine elements 1502 that may be used for storing similar or different sheets 1504, for example. The spine elements 1502 may be detachably or removably coupled to one of the spine elements 1502 adjacent thereto, for example. As discussed above, the size of the spine 1500 may be changed to accommodate additional or less items or materials by changing the number of the spine elements 1502 (e.g., 0, 1, 2, 3, 4, etc.). While not shown, covers may be detachably or removably coupled to the spine elements 1502 as described above.

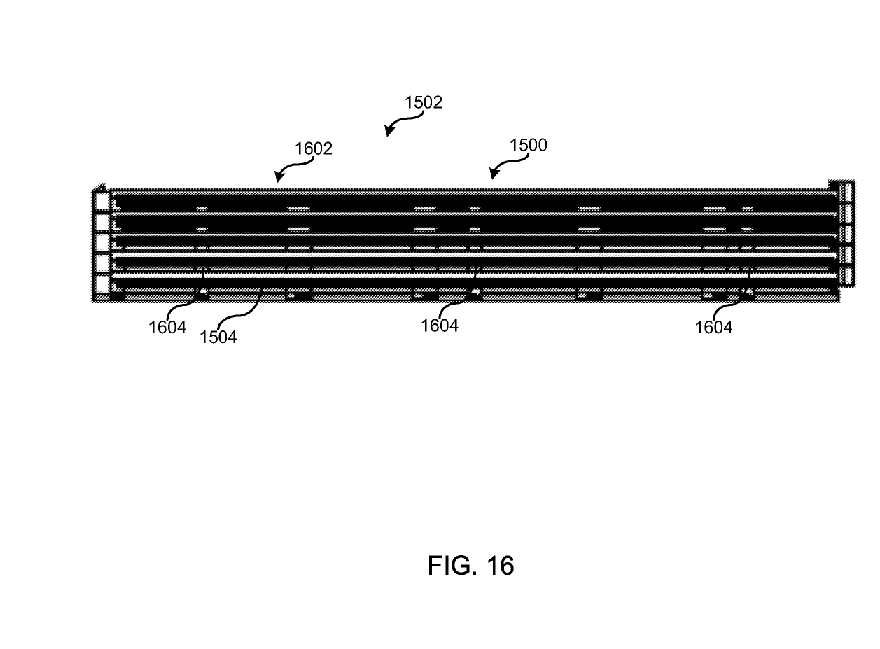

FIG. 16 depicts an interior 1602 of the spine 1500 having the sheets 1504 extending therefrom. At least some of the spine elements 1502 include posts, extensions, pins or pegs 1604. In some examples, the pegs 1604 at least partially facilitate coupling with the spine elements 1502. In some examples, the pegs 1604 facilitate the retaining of the sheets 1504 relative to the spine elements 1502.

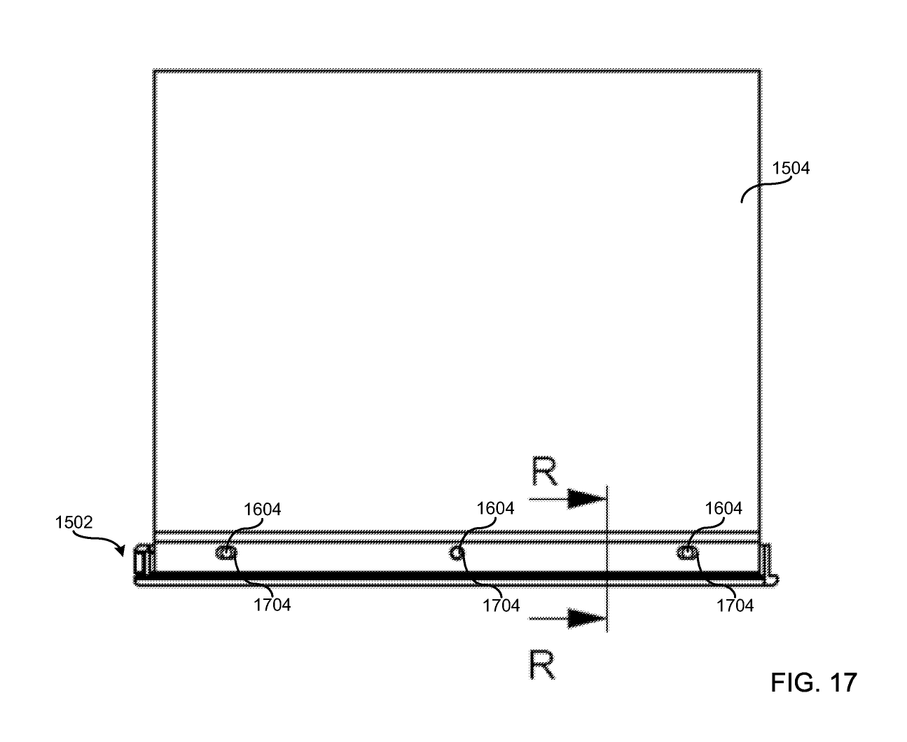

FIG. 17 depicts a side view of the spine elements 1502 and the sheets 1504. In some examples, the sheet 1504 defines a plurality of apertures 1704 that may be similarly or differently sized. The apertures 1704 are sized to enable one of the pegs 1604 to extend through the respective aperture 1704.

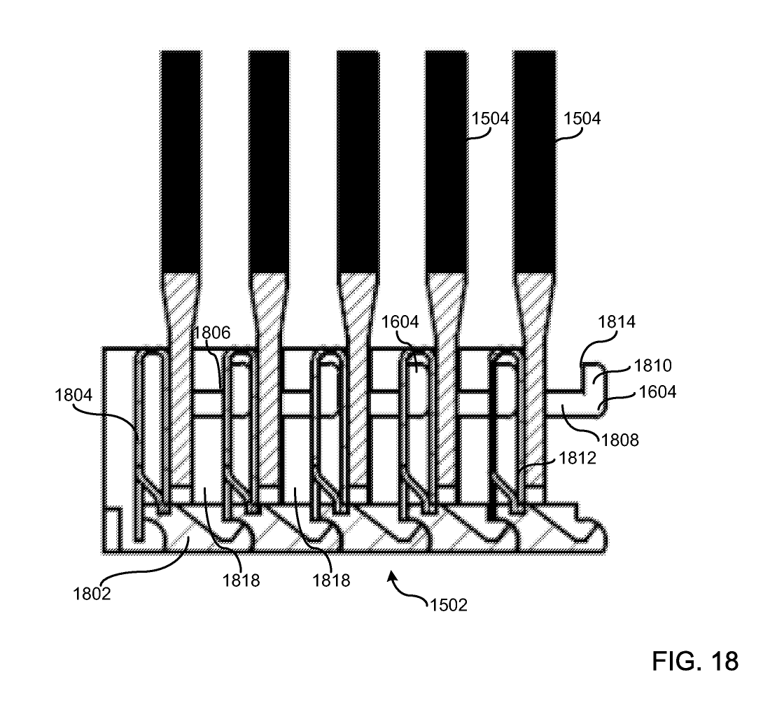

FIG. 18 depicts a cross-sectional view along R-R of FIG. 17. In some examples, the spine elements 1502 may include a first portion 1802 made of a plastic material and a second portion 1804 made of a metal material. The first portion 1802 may be coupled to the second portion 1804 in any suitable way. While the spine elements 1502 are depicted as including two portions, the spine elements 1502 may include any number of portions (e.g., 1, 2, 3, etc.) made of any number of materials (e.g., 1, 2, 3, etc.).

The pegs 1604 may interact with openings 1806 defined by an adjacent spine element 1502 to enable the spine elements 1502 to be coupled and/or relatively stable relative to one another. The pegs 1604 may include an extension or body 1808 and a lip, tab or head 1810, for example. In some examples, the extension 1808 may extend substantially perpendicularly from a surface 1812 of the spine element 1502. In some examples, the lip 1810 may be coupled to an end of the extension 1808. The lip 1810 may include a surface 1814 that interacts with an interior surface 1816 of the spine element 1502 adjacent thereto once the peg 1604 is positioned in the opening 1806. The interaction between the peg 1604 and the interior surface 1816 substantially prevents the pegs 1604 from being removed from the respective opening 1806, for example.

The sheets 1504 may be positioned within one or more gaps 1818 defined between each of the spine elements 1502. The sheets 1504 may be secured within the respective gap 1818 via the pegs 1604.

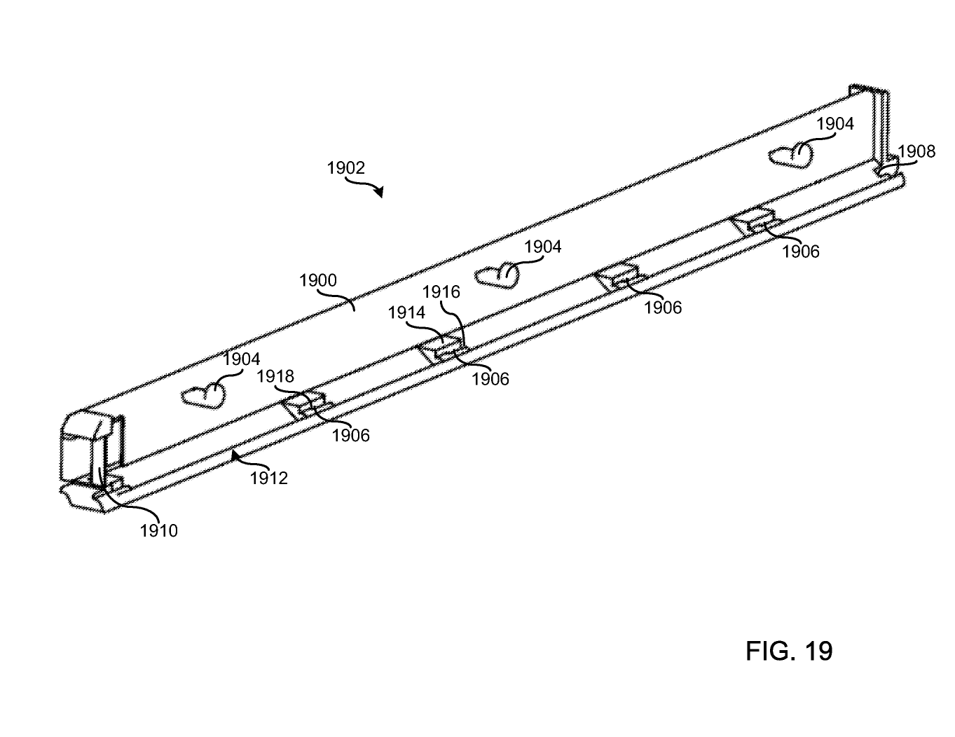

FIG. 19 depicts a first side 1900 of an example spine element 1902. The first side 1900 of the spine element 1902 may include one or more features that enable coupling with and/or stability relative to an adjacent spine element 1502. In some examples, the first side 1900 includes a plurality of pegs 1904 and/or a plurality of groove(s) or slot(s) 1906. In some examples, the first side 1900 includes a notch 1908, a locking fixture 1910 and/or a groove and rib 1912. The pegs 1904, the groove 1906, the notch 1908, the locking fixture 1910 and/or the groove and rib 1912 of the first side 1900 may interact with corresponding surfaces or structures of an opposing side of an adjacent spine element, for example.

In some examples, a structure or block 1914 adjacent the groove 1906 may provide additional reinforcement and additional stability for an adjacent spine element 1902 coupled thereto. In some examples, the structure 1914 defines an opening 1916 of the groove 1906 to enable a rib or lug of an adjacent spine element to enter and/or be positioned within the groove 1906. In some examples, the structure 1914 includes a surface 1918 that may be engaged by a rib or lug of an adjacent spine element once positioned within the groove 1906.

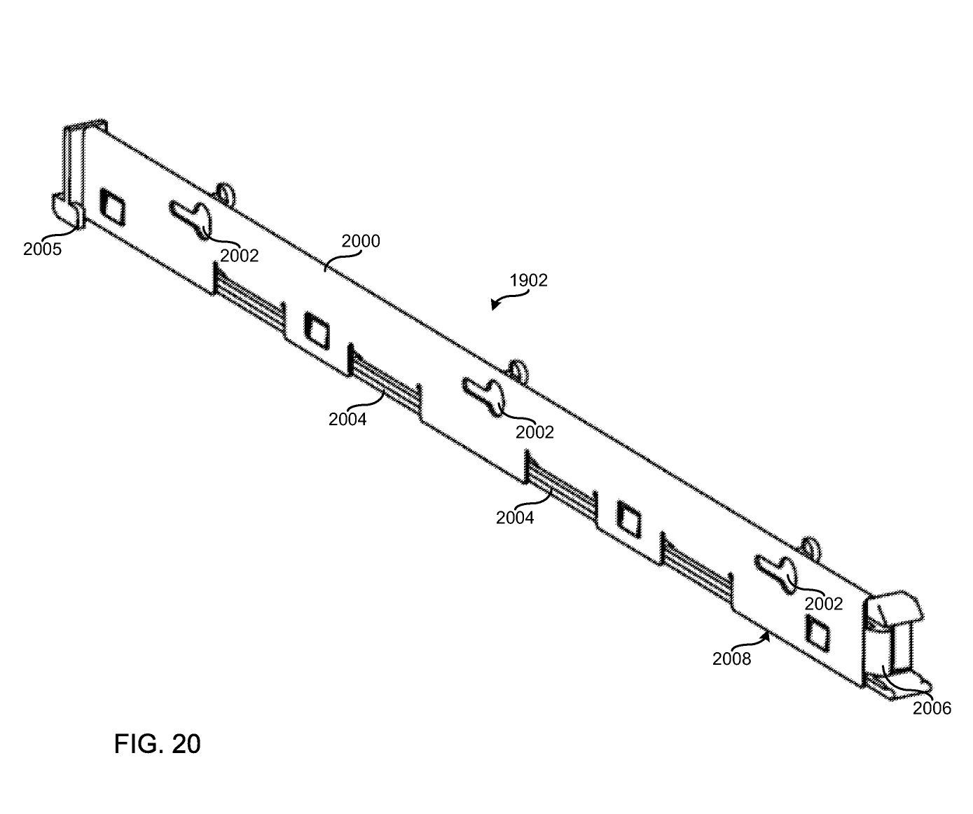

FIG. 20 depicts a second side 2000 of the example spine element 1902. The second side 2000 of the spine element 1902 may include one or more features that enable coupling with and/or stability relative to an adjacent spine element 1502. In some examples, the second side 2000 includes a plurality of first openings 2002 and/or a plurality of second openings 2004. In some examples, the second side 2000 includes an extension 2005, a biasing or locking element 2006 and/or a groove and rib 2008. The openings 2002, the openings 2004, the extension 2005, the locking element 2006 and/or the groove and rib 2008 of the second side 2000 may interact with corresponding surfaces or structures of an opposing side of an adjacent spine element, for example.

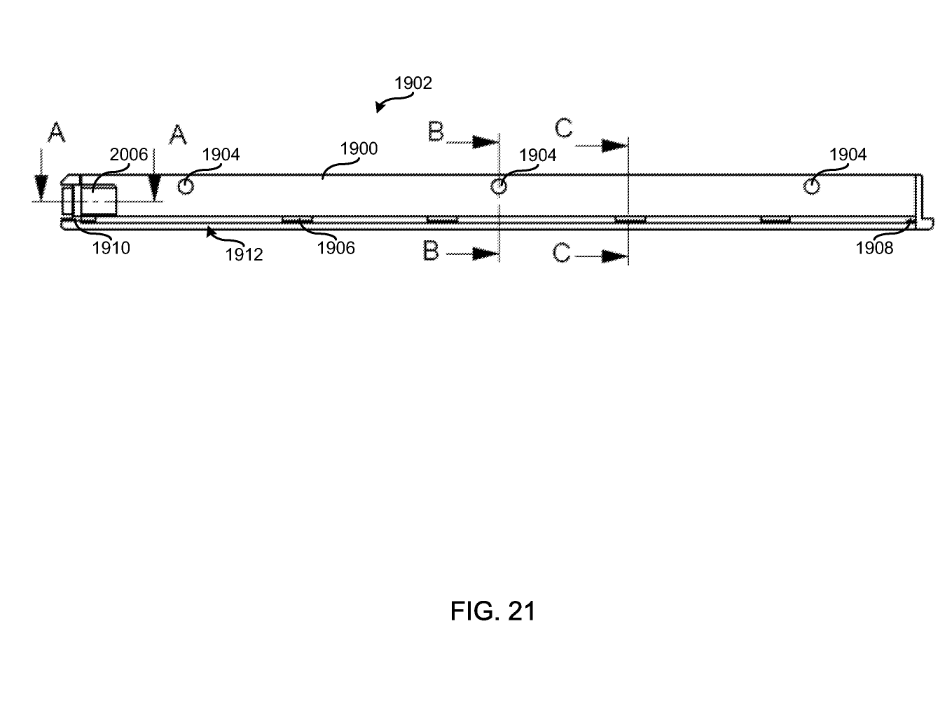

FIG. 21 depicts a different view of the first side 1900 of the spine element 1902. In some examples, a portion of the locking element 2006 of the second side 2000 may be adjacent to the first side 1900.

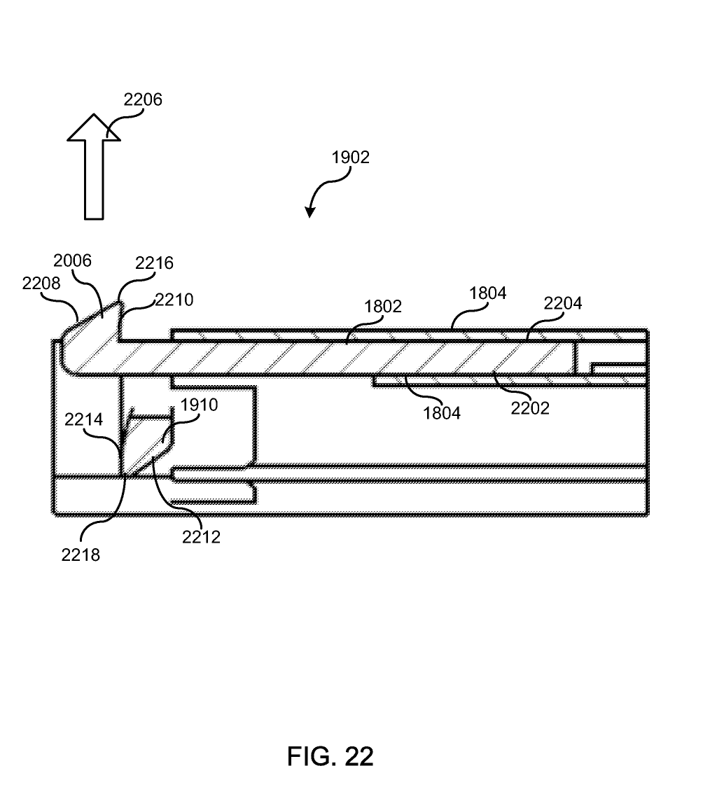

FIG. 22 depicts a cross-sectional view along A-A of FIG. 21 that illustrates a detailed view of the locking element 2006 and the locking fixture 1910. The locking element 2006 and the locking fixture 1910 may be made of similar or different materials. In some examples, the locking element 2006 and the locking fixture 1910 may be part of the first portion 1802 and may be made of a plastic material.

The locking element 2006 may be positioned between opposing surfaces 2202 and 2204 of the second portion 1804. In some examples, the second portion 1804, via the surface 2202, may bias the locking element 2006 in a direction generally indicated by arrow 2206. In some examples, the locking element 2006 may be elastic and/or elastically deformable.

The locking element 2006 may include a tapered surface 2208 and a step 2210 that may interact with corresponding surfaces of an opposing side of an adjacent spine element.

The locking fixture 1910 includes a ramp or tapered surface 2212 and a locking surface 2214 that may interact with corresponding surfaces of an opposing side of an adjacent spine element.

In practice, as opposing sides (e.g., the first side, the second side) of two adjacent substantially similar spine elements 1902 are moved relative to one another, the tapered surface 2208 of the locking element 2006 of one of the spine elements 1902 may engage the tapered surface 2212 of the locking fixture 1910 of the other one of the spine elements 1902 compressing the locking element 2006 (e.g., moves the locking element in a direction substantially opposite the direction generally indicated by arrow 2206). The spine elements 1502 may be further moved relative to one another until an edge 2216 of the locking element 2006 is past an edge 2218 of the locking fixture 1910. Once past the edge 2218, the locking element 2006 may extend such that the step 2210 is positioned adjacent to the locking surface 2114. The interaction between the locking element 2006 and the locking fixture 1910 at least partially enables the spine elements 1502 to be coupled and/or relatively stable relative to one another, for example.

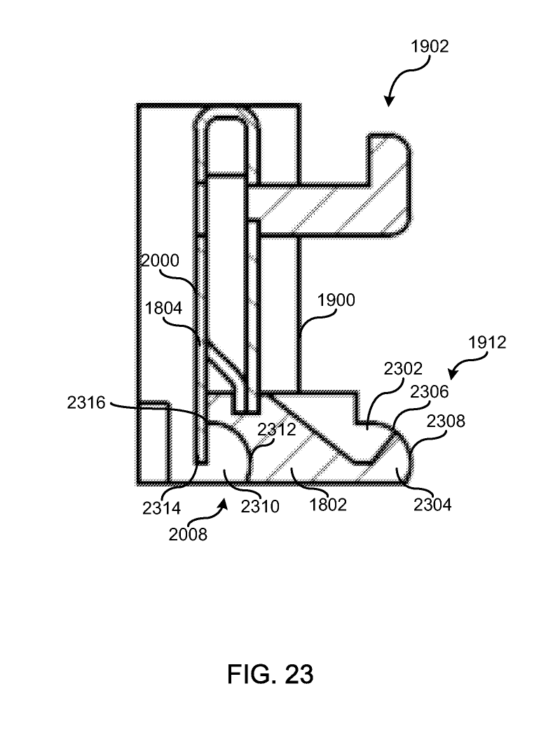

FIG. 23 depicts a cross-sectional view along B-B of FIG. 21 that illustrates a detailed view of the groove and rib 1912 of the first side 1900 and the groove and rib 2008 of the second side 2000.

In some examples, the groove and rib 1912 includes a groove or channel 2302 defined by the first portion 1802. In some examples, the groove and rib 1912 includes a rib 2304 that at least partially defines the groove 2302. The rib 2304 may include a corner 2306 and a curved surface 2308.

In some examples, the groove and rib 2008 includes a groove 2310 defined by the first portion 1802 and the second portion 1804. The portion of the groove 2310 defined by the first portion 1802 includes a curved surface 2312; however, any other suitable shape may be used instead. In some examples, the groove and rib 422 includes a rib or lug 2314 of the second portion 1804 that may slightly extend past an edge 2316 of the first portion 1802. The rib 2314 may at least partially define the groove 2310.

In practice, as opposing sides of two adjacent substantially similar spine elements 1902 are interacting with to one another, the rib 2314 may be at least partially positioned within the groove 2302 and the rib 2304 is to be at least partially within the groove 2310. In some examples, the corner 2306 of the rib 2304 facilitates the initial positioning of the rib 2304 relative to the groove 2310. In some examples, the curved surface 2308 of the rib 2304 corresponds to the curved surface 2312 of the groove 2310.

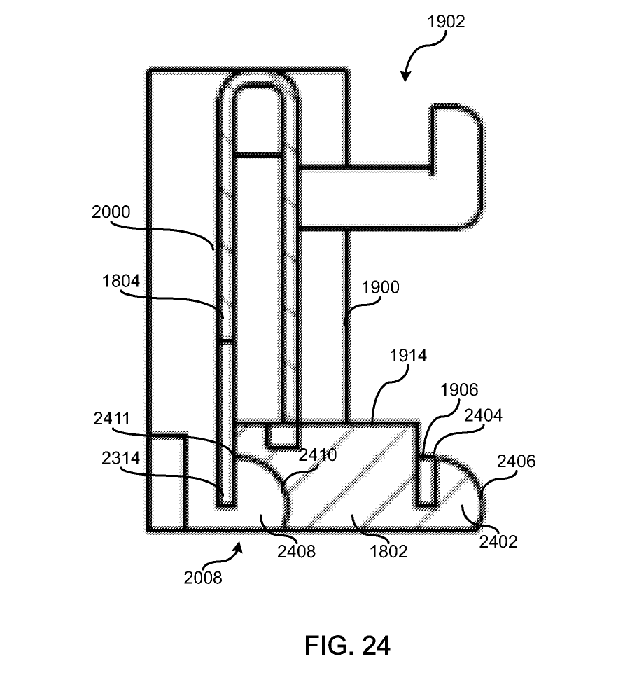

FIG. 24 depicts a cross-sectional view along C-C of FIG. 21 that illustrates a detailed view of the groove 1906 of the first side 1900 and the groove and rib 2008 of the second side 2000.

In some examples, the groove 1906 is defined by the first portion 1802. In some examples, a rib 2402 of the first portion 1802 at least partially defines the groove 1906. The rib 2402 may include a corner 2404 and a curved surface 2406.

In some examples, the rib 2314 of the groove and rib 2008 may be part of the second portion 1804. In some examples, a groove 2408 is positioned adjacent to the rib 2314. The groove 2408 may be defined by a curved surface 2410 of the first portion 1802 and the rib 2314.

In practice, as opposing sides of two adjacent substantially similar spine elements 1902 are interacting with one another and/or moved to a final locking position, the rib 2314 may be at least partially positioned within the groove 1906 and the rib 2402 is to be at least partially within the groove 2408. In some examples, the corner 2404 of the rib 2402 is to be positioned adjacent to a corner 2411 defined by the curved surface 2410 and the rib 2314. In some examples, the curved surface 2406 of the rib 2402 corresponds to the curved surface 2410 of the groove 2408.

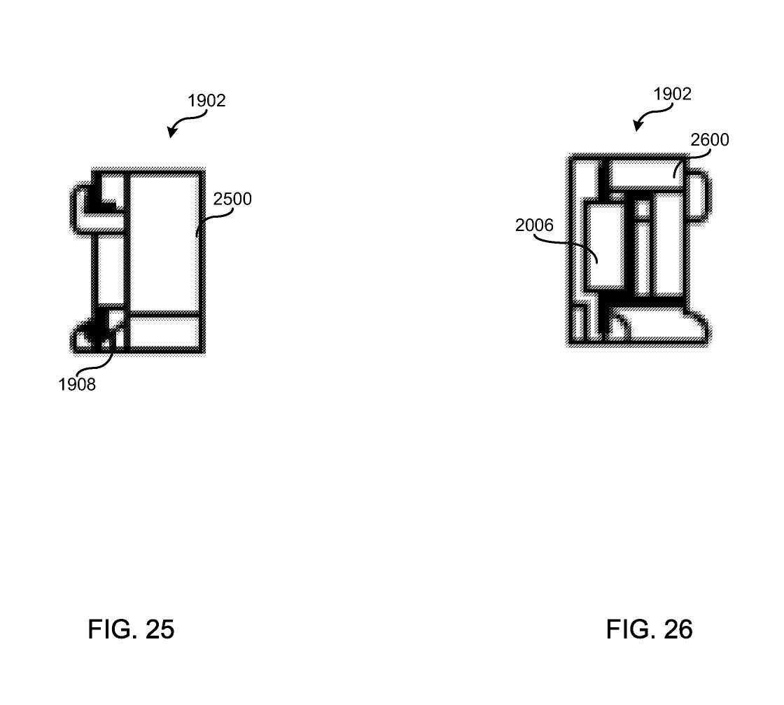

FIG. 25 depicts a first end 2500 of the spine element 1902 having the notch 908. FIG. 26 depicts a second end 2600 of the spine element 1902 having the locking element 2006.

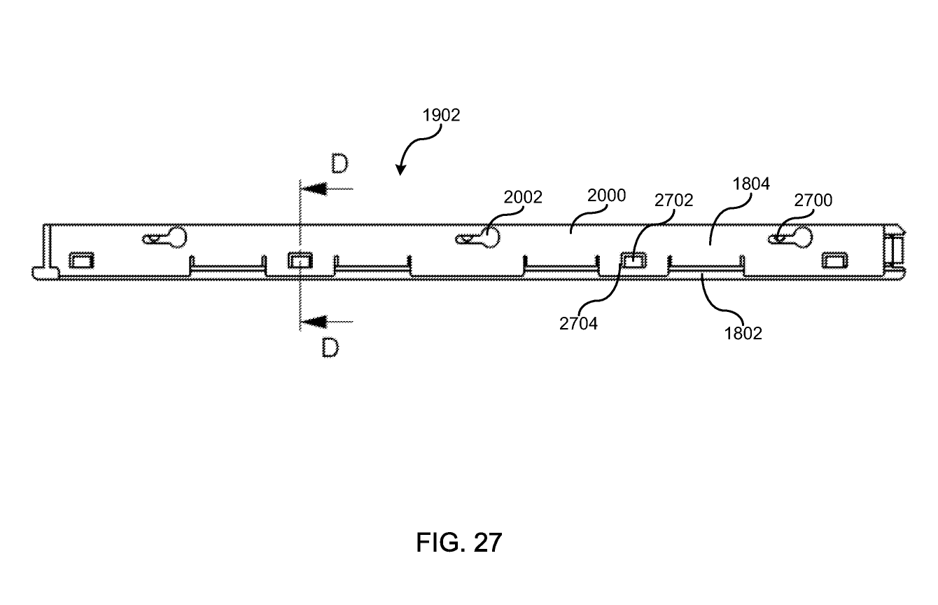

FIG. 27 depicts a different view of the second side 2000 of the spine element 1902. In some examples, locking elements 2700 may be positioned in an interior of the second portion 1804 adjacent the openings 2002. The locking elements 2700 may be pins that are welded or riveted within the respective openings 2002, for example. In such examples, when the pegs 1904 are positioned in the openings 2002, the interaction between the pegs 1904 and the locking elements 2700 may additionally secure and/or position the pegs 1904 within the opening 2002, for example.

In some examples, tabs or snapper ramps 2702 of the first portion 1802 may interact with openings 2704 of second portion 1804 to secure and/or couple the portions 1802 and 1804 together. The interaction between the tabs 2702 and the respective opening 2704 may enable the portions 1802 and 1804 to be secured relative to one another without the use of fasteners, for example.

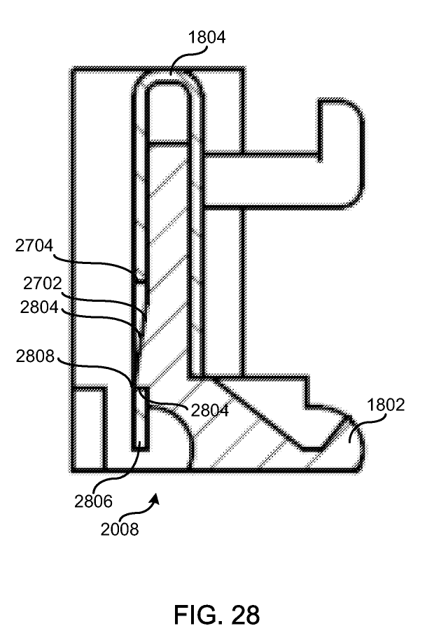

FIG. 28 depicts a cross-sectional view along D-D of FIG. 27 that illustrates a detailed view of one of the openings 2704 of the second portion 1804 and one of the tabs 2702 of the first portion 1802. The second portion 1804 may at least partially have a U-shaped profile. In some examples, the tab 2702 includes a tapered or inclined surface 2802 and a step 2804. In practice, the portions 1802 and 1804 may be moved relative to one another such that an end 2806 of the second portion 1804 engages the tapered surface 2802. This engagement may elastically deform the second portion 1804 until a surface or edge 2808 of the opening 2704 is past the tapered surface 2802. The end 2806 may then be positioned adjacent to the step 2804 at least partially securing the portions 1802 and 1804 together.

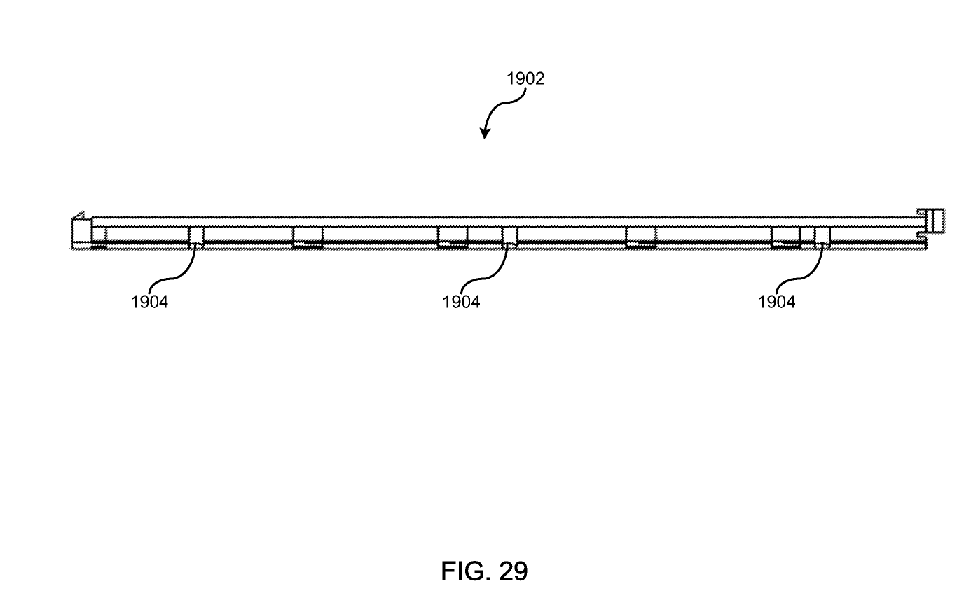

FIG. 29 depicts a top view of the spine element 1902.

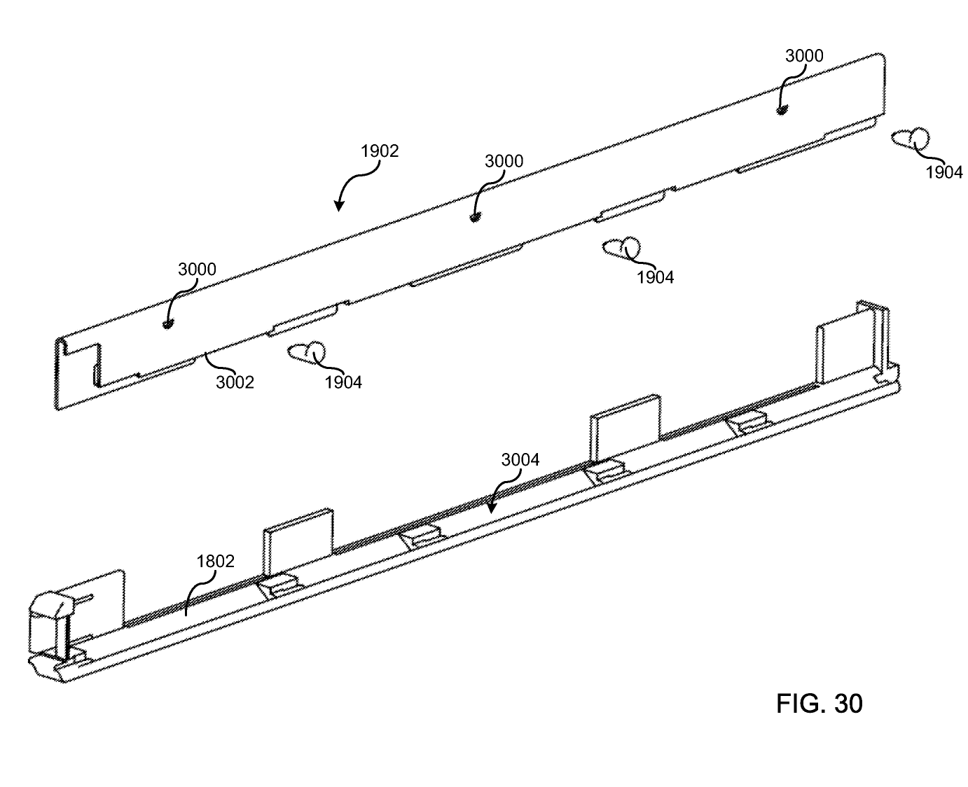

FIG. 30 depicts an exploded view of the spine element 1902. The first portion 1802 is separated from the second portion 1804. The pegs 1904 are separated from the second portion 1804. In some examples, the second portion 1804 may define a plurality of apertures 3000 to facilitate coupling with the pegs 1904. The apertures 3000 may be semi-circular in shape or any other shape such as a circle, oval, square, rectangle, etc. A portion of the pegs 1904 may correspond to the shape of the apertures 3000 and at least partially extend into the aperture 3000 to facilitate coupling.

In some examples, an edge and/or profile 3002 of the second portion 1804 corresponds to a surface and/or profile 3004 of the first portion 1802 to facilitate coupling therewith.

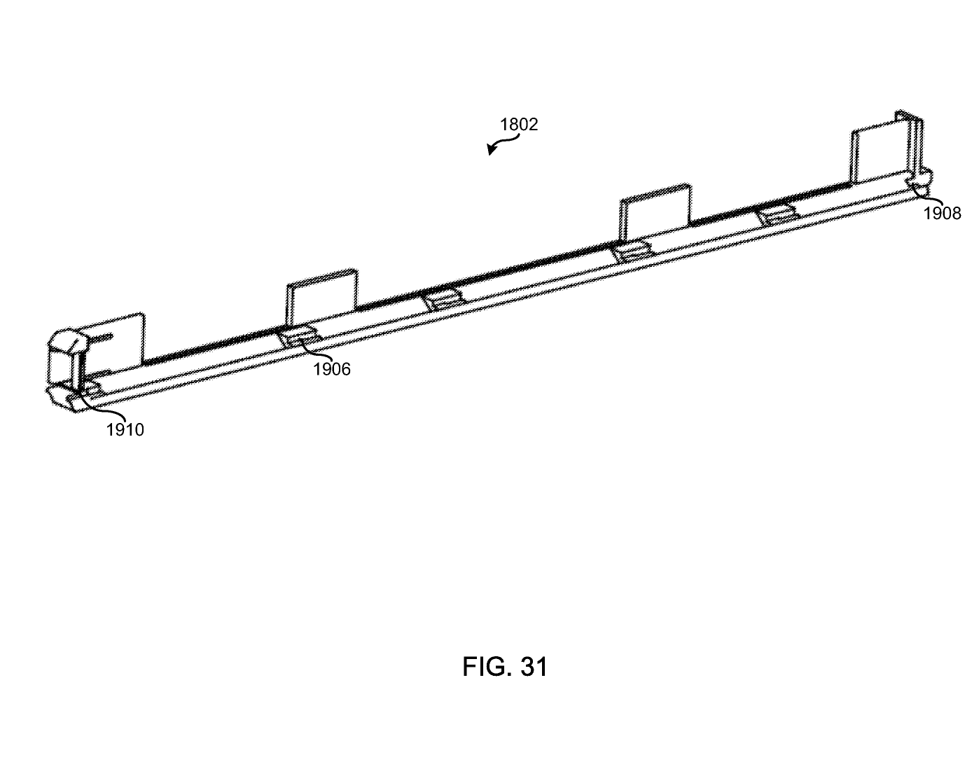

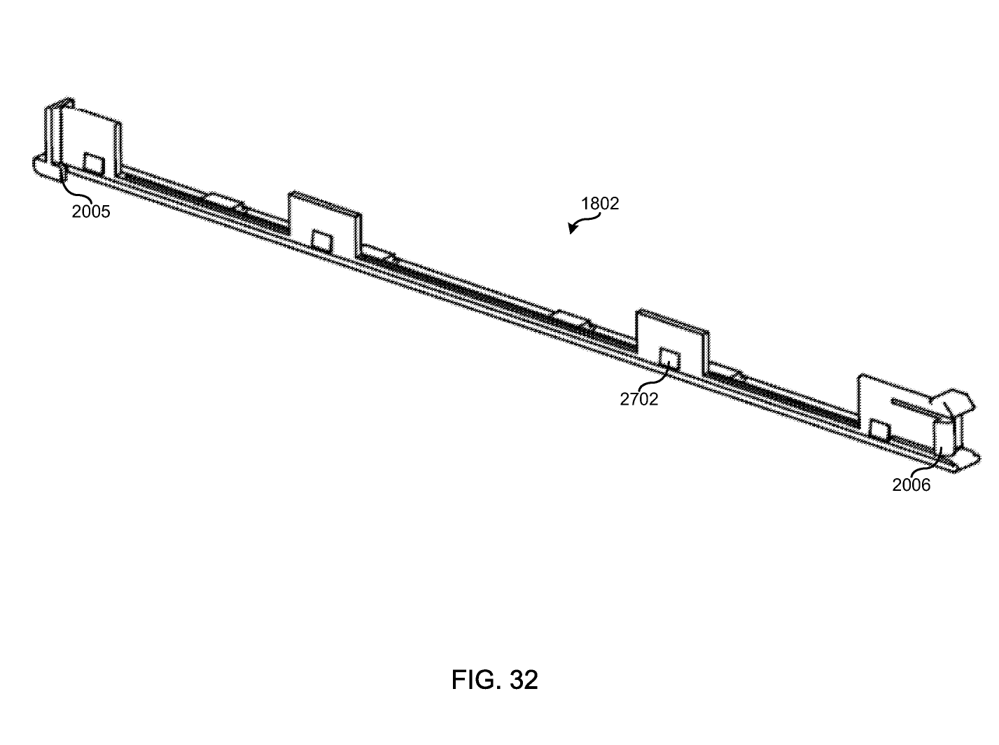

FIGS. 31 and 32 depict different views of the first portion 1802.

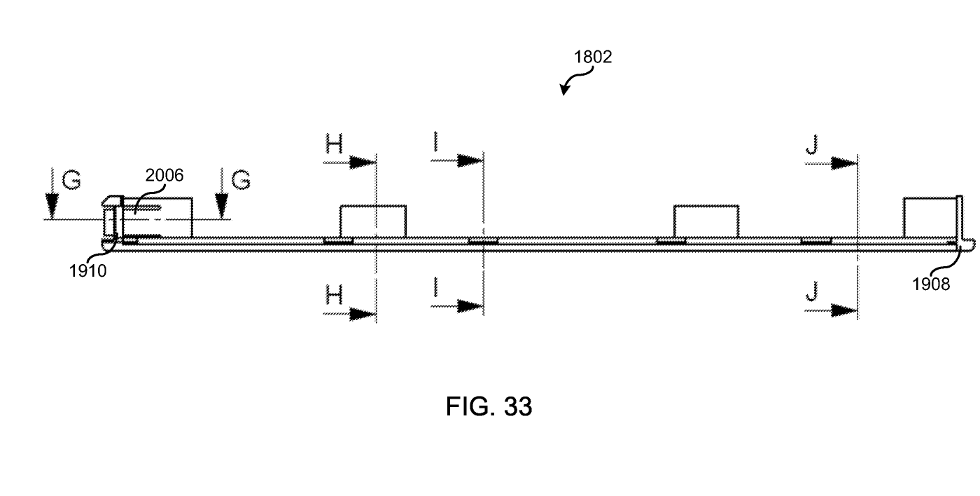

FIG. 33 depicts a different view of the first portion 1802.

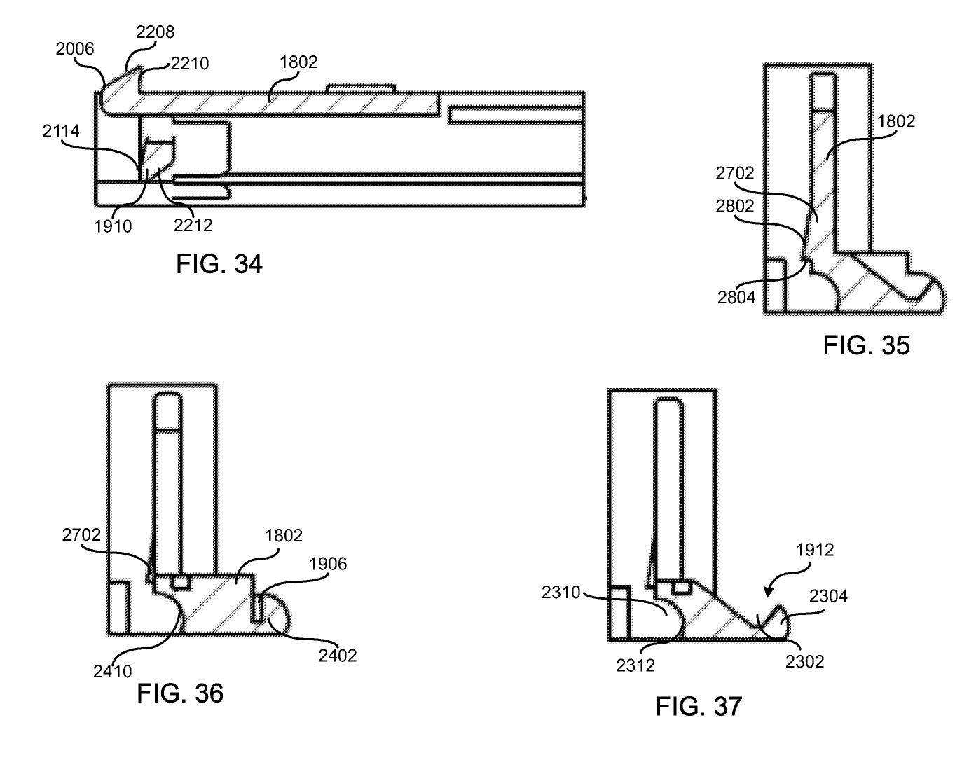

FIG. 34 depicts a cross-sectional view along G-G of FIG. 33 that illustrates a detailed view of the locking element 2006 and the locking fixture 1910.

FIG. 35 depicts a cross-sectional view along H-H of FIG. 33 that illustrates a detailed view of one of the tabs 2702 of the first portion 1802.

FIG. 36 depicts a cross-sectional view along I-I of FIG. 33 that illustrates a detailed view of the groove 1906 and the tab 2702.

FIG. 37 depicts a cross-sectional view along J-J of FIG. 33 that illustrates a detailed view of the groove and rib 1912 and the groove 2310.

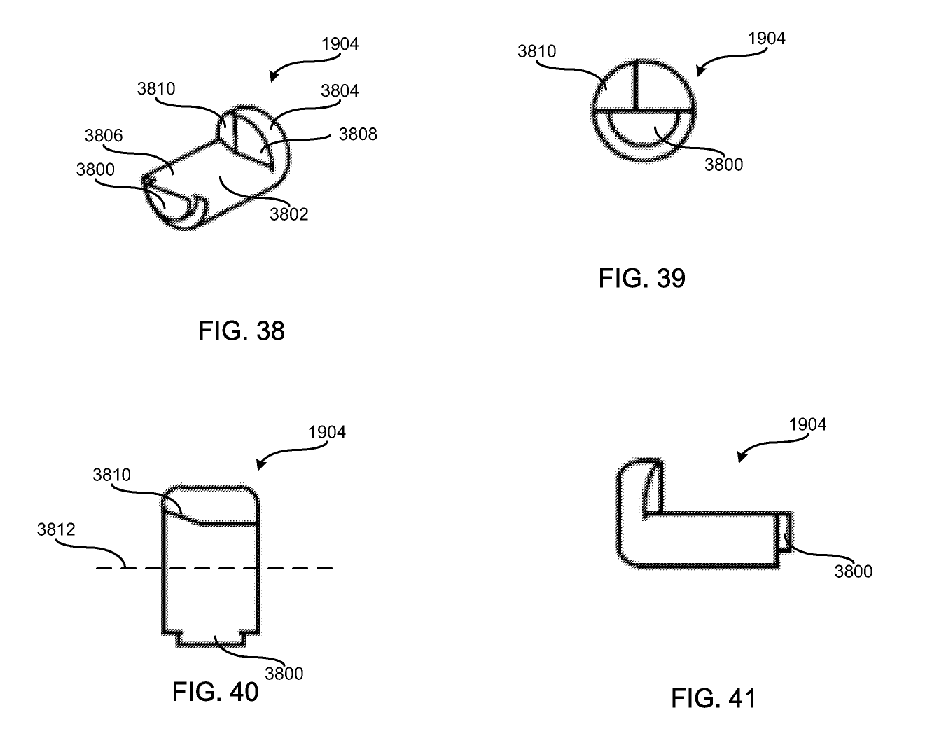

FIGS. 38-41 depict different views of the pegs 1904. In some examples the peg 1904 includes a portion or semi-circular extension 3800 that may be positioned in the apertures 3000 to facilitate coupling therewith. In some examples, the peg 1904 includes a body 3802 and a head 3804. While the body 3802 is depicted as having a semi-circular cross-section, the body 3802 may have any other shape and/or cross-section such as circular, rectangular, etc.

The head 3804 may extend substantially perpendicularly from a surface 3806 of the body 3802, for example. In some examples, the head 3804 includes a first surface 3808 and a second surface 3810. The first surface 3808 may be substantially parallel to a lateral axis 3812 of the peg 1904, for example. The second surface 3810 may be at a substantially non-parallel angle relative to the lateral axis 3812 of the peg 1904. The angle of the second surface 3810 may facilitate relatively easy interaction and/or locking between the peg 1904 and the opening 2002, for example. The angle of the second surface 3810 may facilitate relatively easy interaction and/or locking between the peg 1904 and the openings of a retaining bar, for example. While a particular angle of the second surface 3810 is depicted, the second surface 3810 may be at any other angle including a substantially parallel angle relative to the lateral axis 3812, for example.

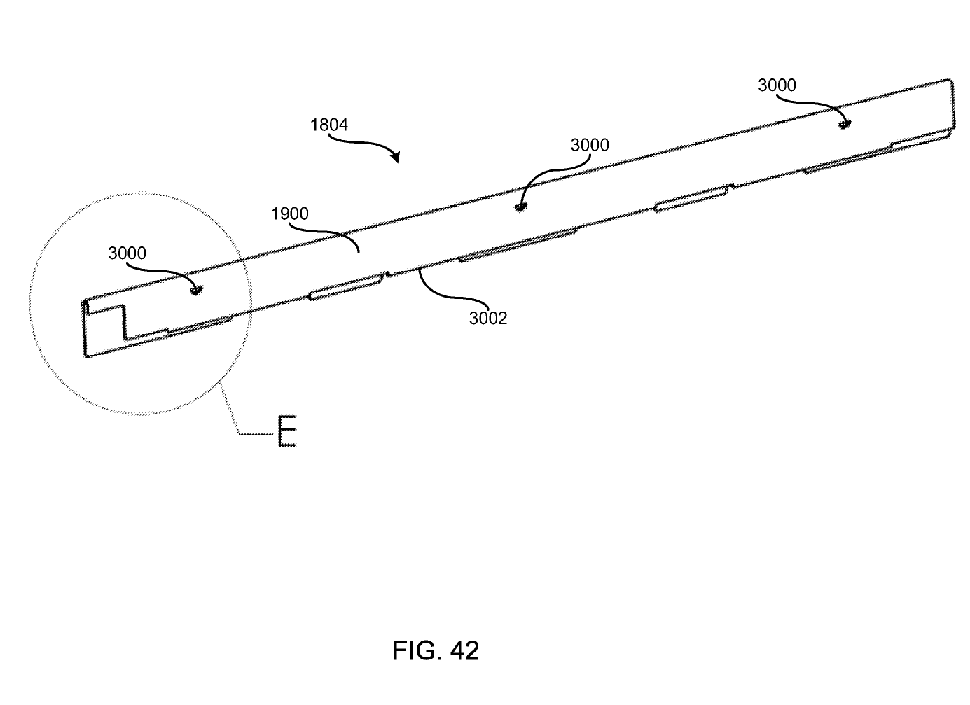

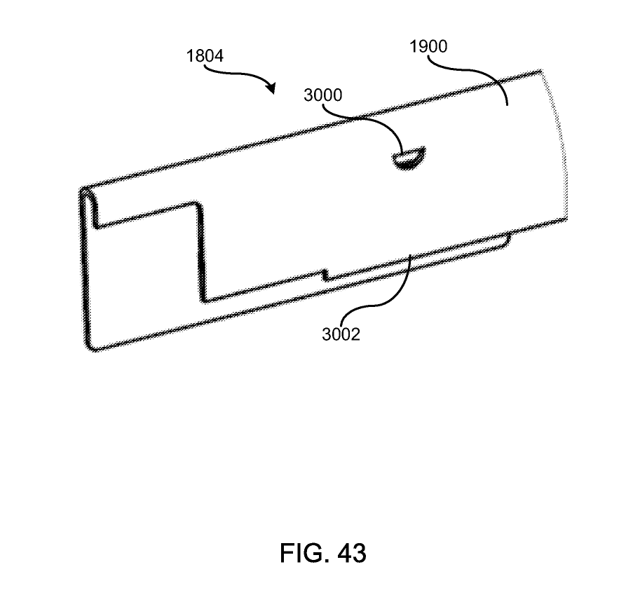

FIG. 42 depicts a view of the first side 1900 of the second portion 1804 and FIG. 43 depicts a detailed view of one of the apertures 3000, which is circled on FIG. 42 and identified by “E”.

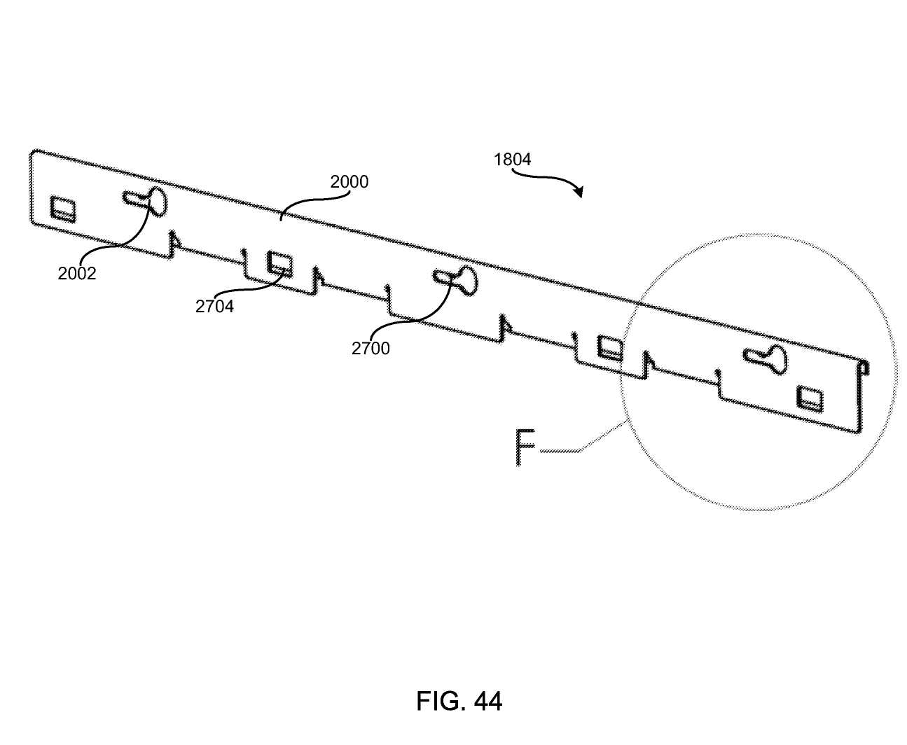

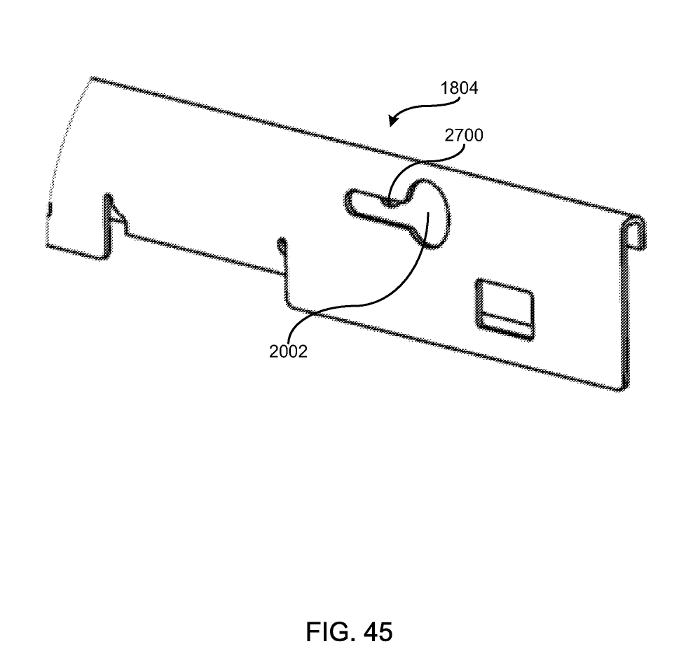

FIG. 44 depicts a view of the second side 2000 of the second portion 1804 and FIG. 45 depicts a detailed view of one of the openings 2002, which is circled on FIG. 44 and identified by “F”.

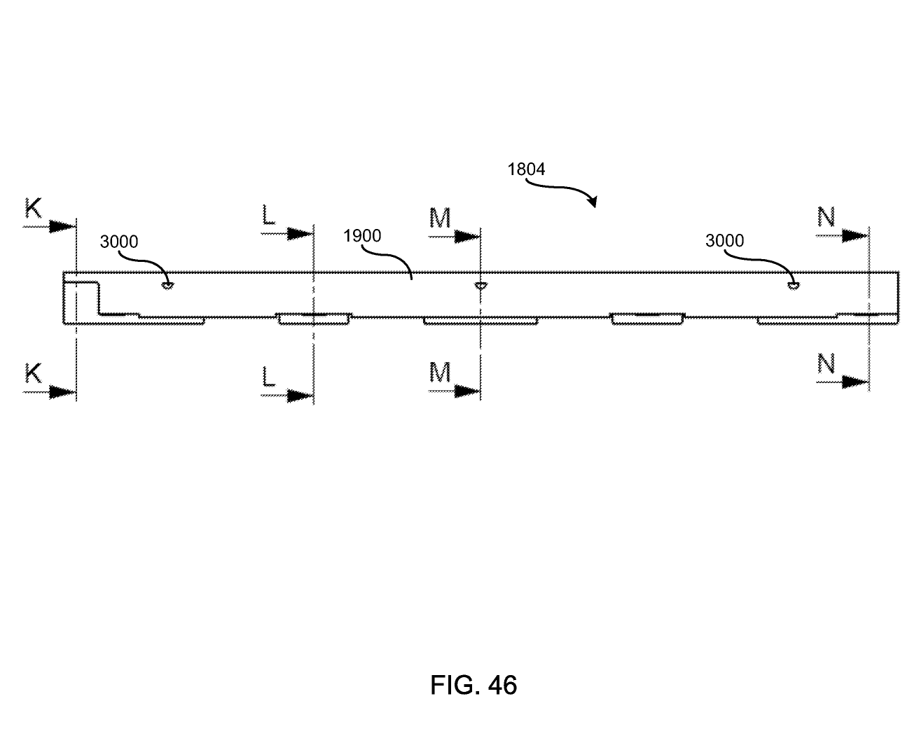

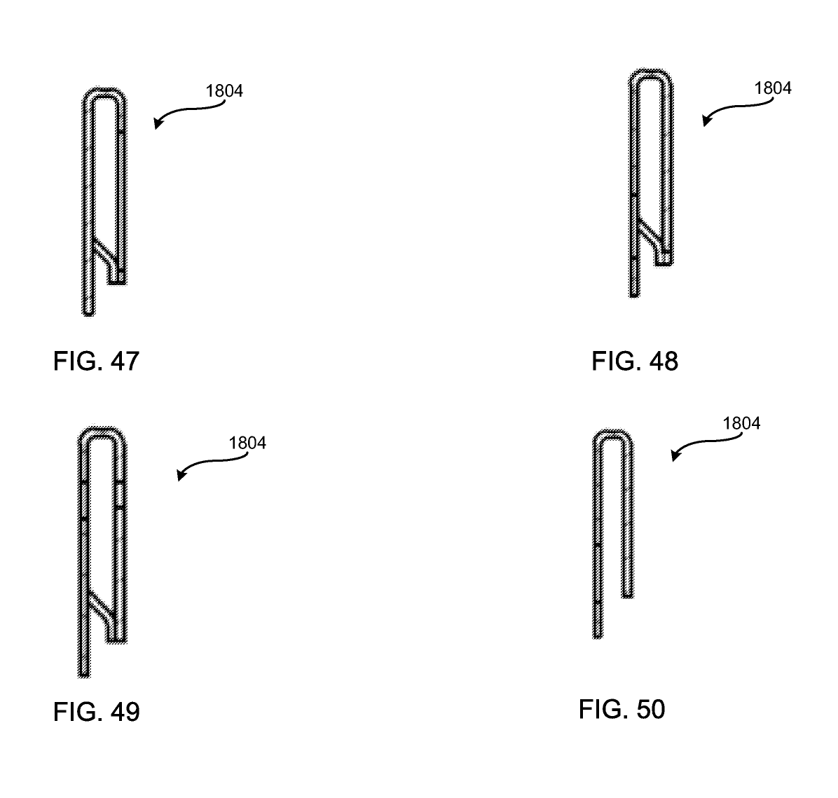

FIG. 46 depicts a view of the first side 1900 of the second portion 1804. FIG. 47 depicts a cross-sectional view of the second portion 1804 along K-K of FIG. 46. FIG. 48 depicts a cross-sectional view of the second portion 1804 along L-L of FIG. 46. FIG. 49 depicts a cross-sectional view of the second portion 1804 along M-M of FIG. 46. FIG. 50 depicts a cross-sectional view of the second portion 1804 along N-N of FIG. 46.

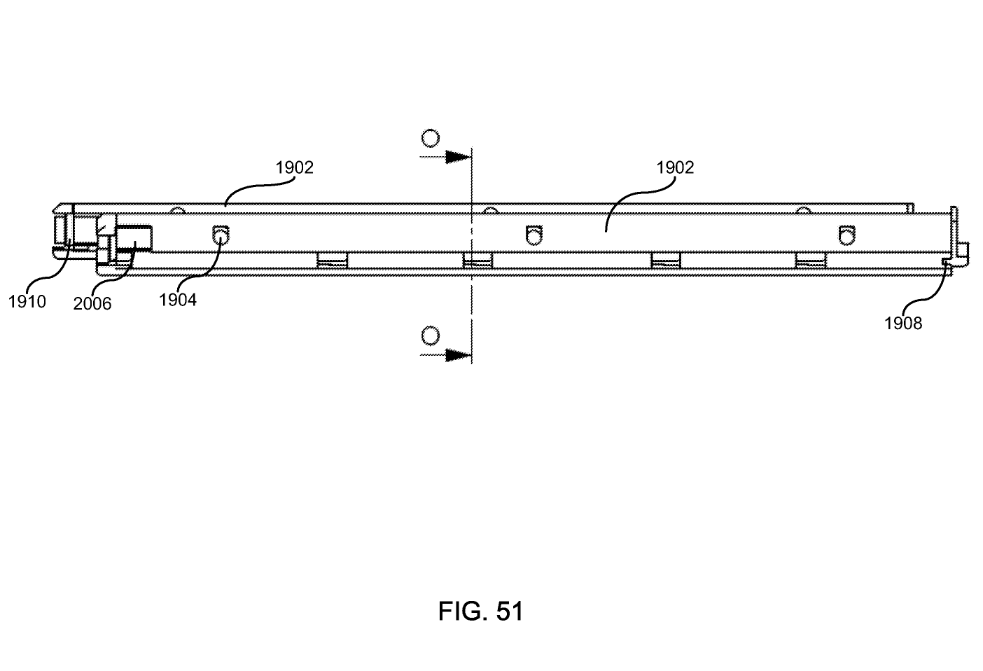

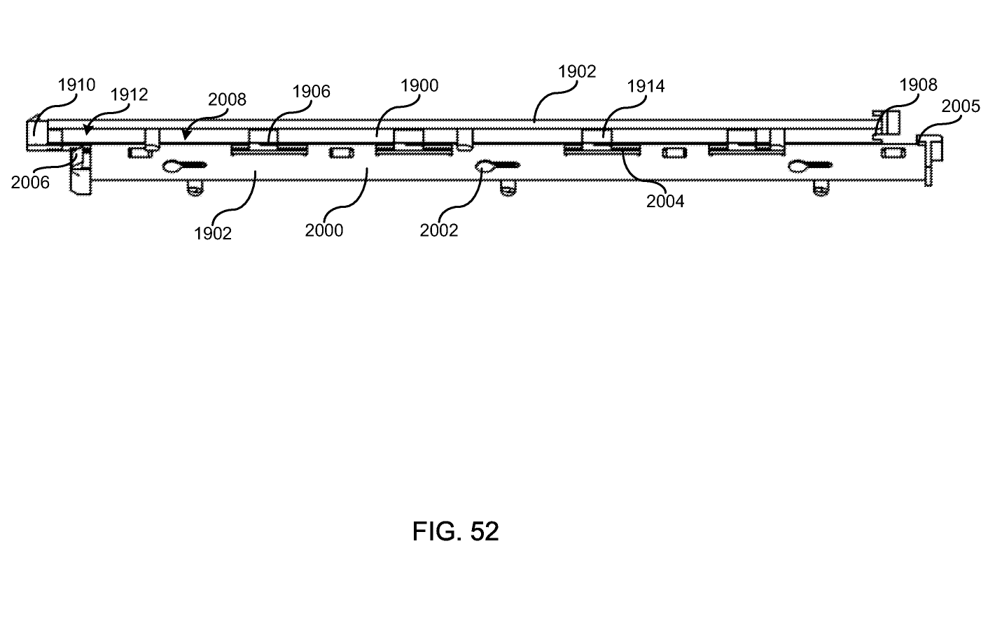

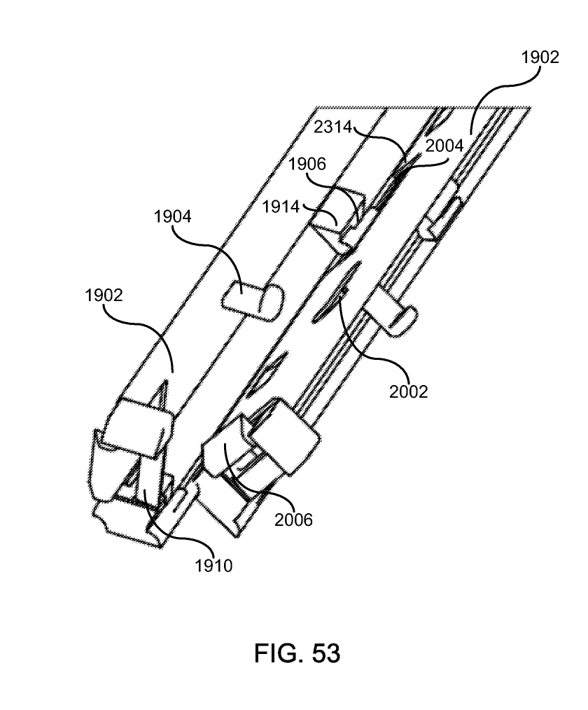

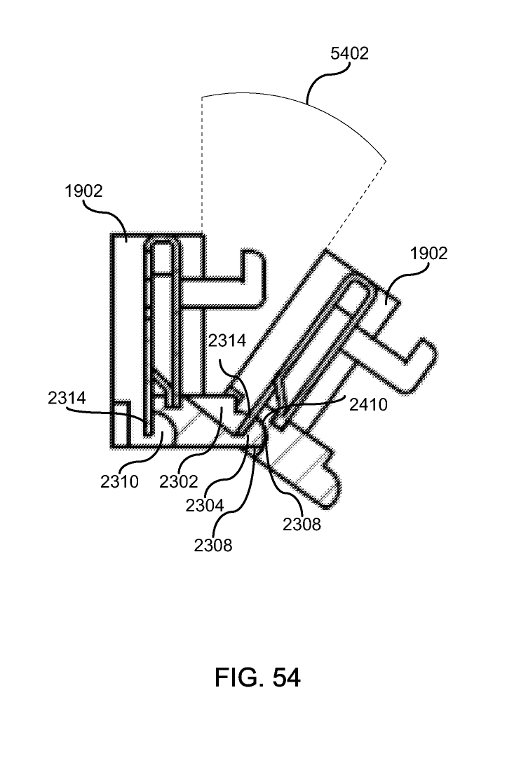

FIGS. 51-54 depict various views of two of the spine elements 1902 in the process (e.g., the initial or first stage) of being coupled together. To facilitate this coupling, some of the features of first side 1900 of one of the spine elements 1902 interact with some of the features of the second side 2000 of the other one of the spine elements 1902. To initiate the coupling between the spine elements 1902, the spine elements 1902 may at least initially be offset relative to one another and may be positioned at a non-parallel angle 5402 relative to one another (shown most clearly in FIGS. 53 and 54).

In some examples, at least when the spine elements 1902 are positioned at the non-parallel angle 5402 relative to one another, the structure 1914 of the first side 1900 may interact with the openings 2004 of the second side 2000. In some examples, at least when the spine elements 1902 are positioned at the non-parallel angle 5402 relative to one another, the groove and rib 1912 of the first side 1900 may interact with the groove and rib 2008 of the second side 2000.

FIG. 53 clearly depicts the interaction between the structure 1914 and the opening 2004. FIG. 54 is a cross-sectional view along O-O of FIG. 51 and clearly depicts the interaction between the rib 2304 and the groove 2408, the interaction between the curved surfaces 2308 and 2410 and the interaction between the rib 2314 and the groove 2302, for example.

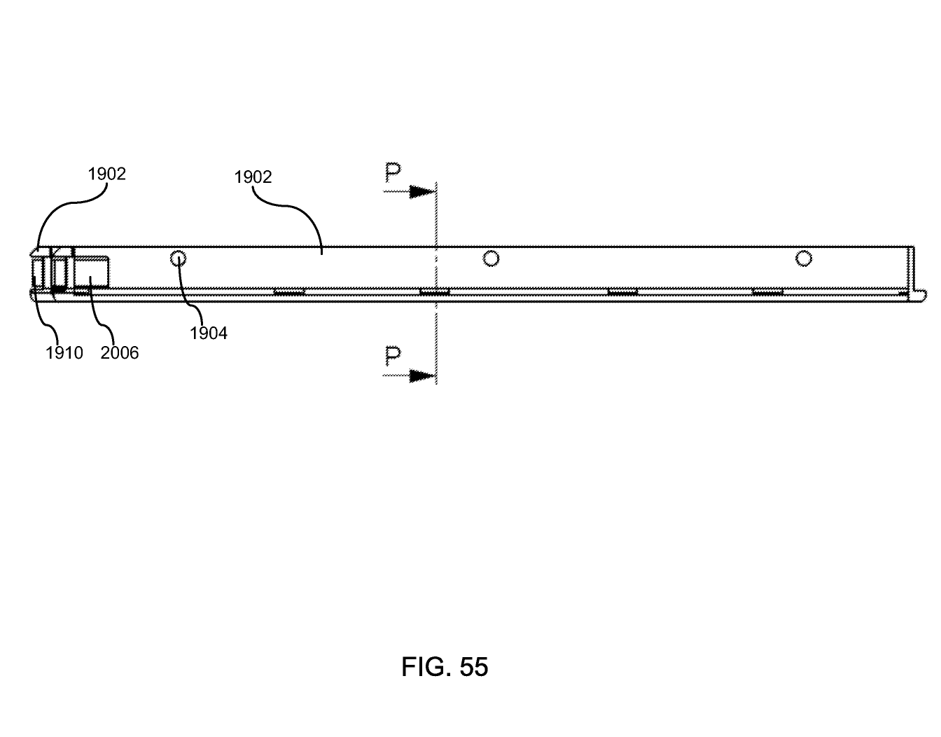

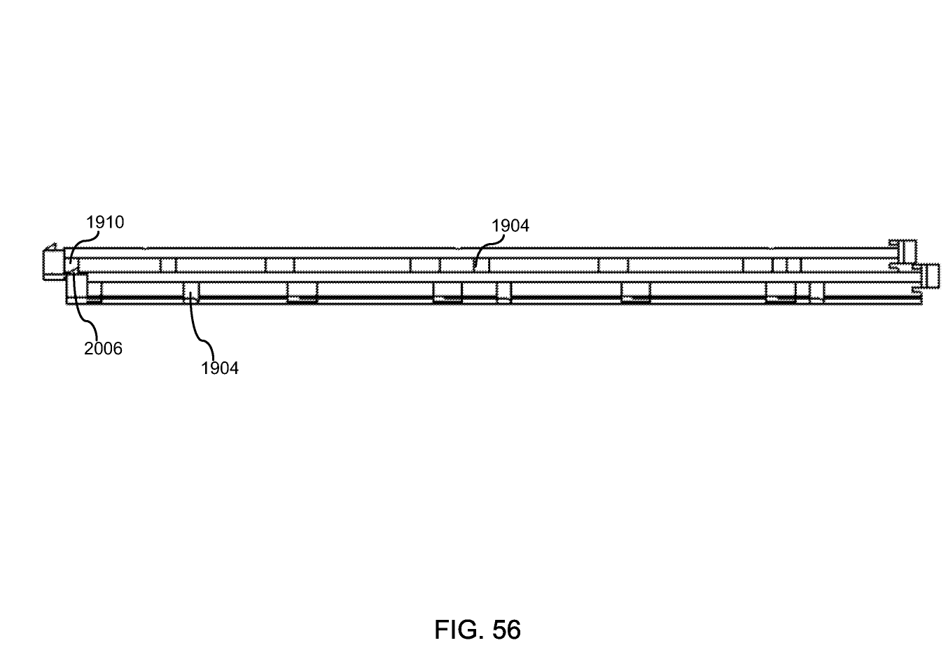

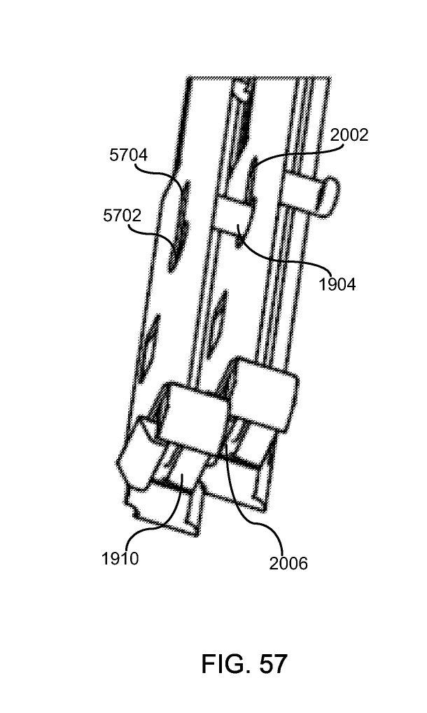

FIGS. 55-58 depict various views of two of the spine elements 1902 in the process (e.g., the next or second stage) of being coupled together. To move from the first stage depicted in FIGS. 51-54, to the second stage depicted in FIGS. 55-58, the spine elements 1902 may be pivoted relative to one another such that spine elements 1902 are substantially parallel to one another. As the spine elements 1902 are moved relative to one another, the pegs 1904 of one of the spine elements 1902 move toward the openings 2002 of the other one of the spine elements 1902. In the position depicted in FIGS. 55-58, the spine elements 1902 may be laterally displaced and/or offset relative to one another, for example.

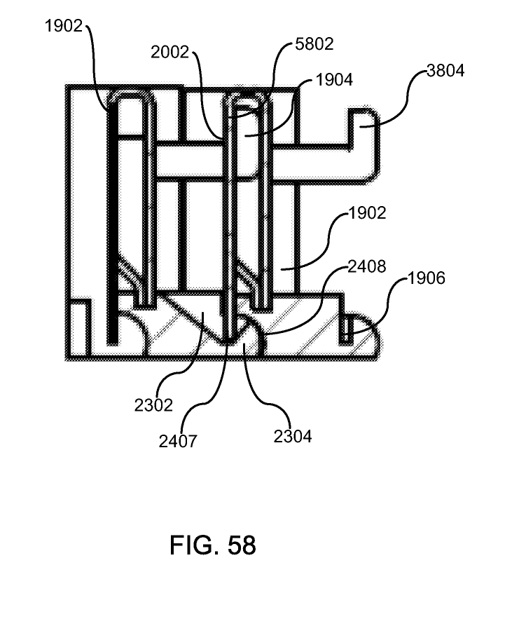

Once the spine elements 1902 are substantially parallel, the head 3804 of the peg 1904 enters or is at least partially positioned within a first portion 5702 of the respective opening 2002. The first portion 5702 may be sized to receive the head 3804 of the peg 1904. As discussed above, the openings 2002 may have the first portion 5702 and a second portion 5704 different from the first portion 5702. In some examples, once the spine elements 1902 are further moved relative to one another, as discussed below, an interior surface 5802 adjacent the second portion 5704 interacts with the head 3804 to substantially prevent the peg 1904 from being removed from the opening 2002. FIG. 58 is a cross-sectional view along P-P of FIG. 55.

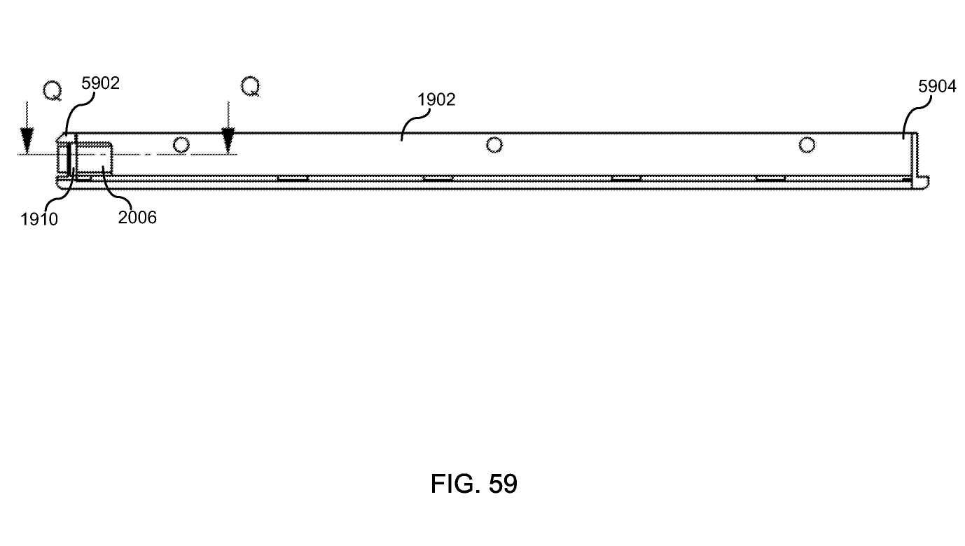

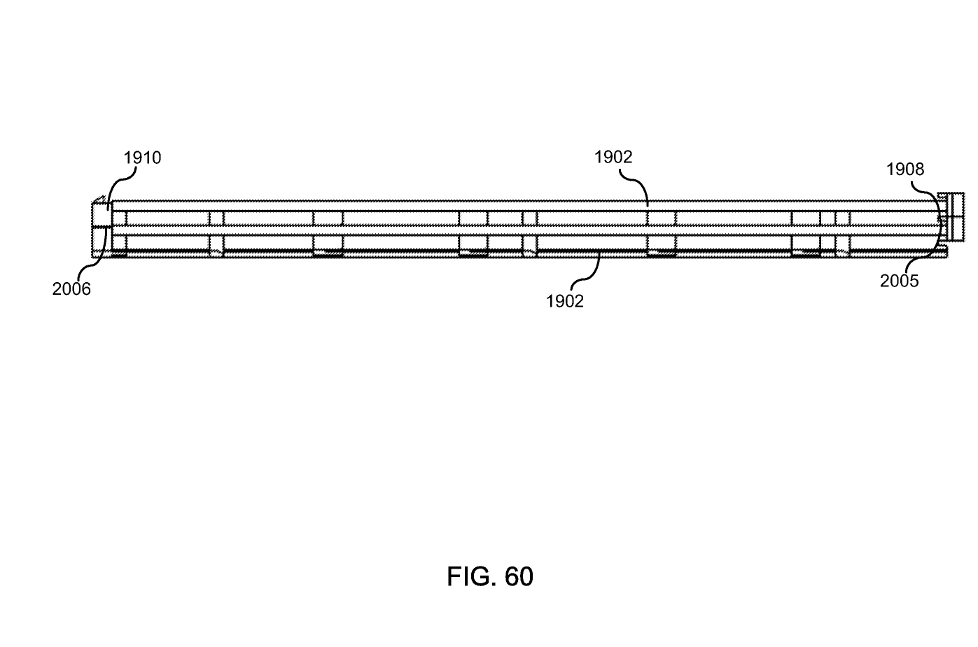

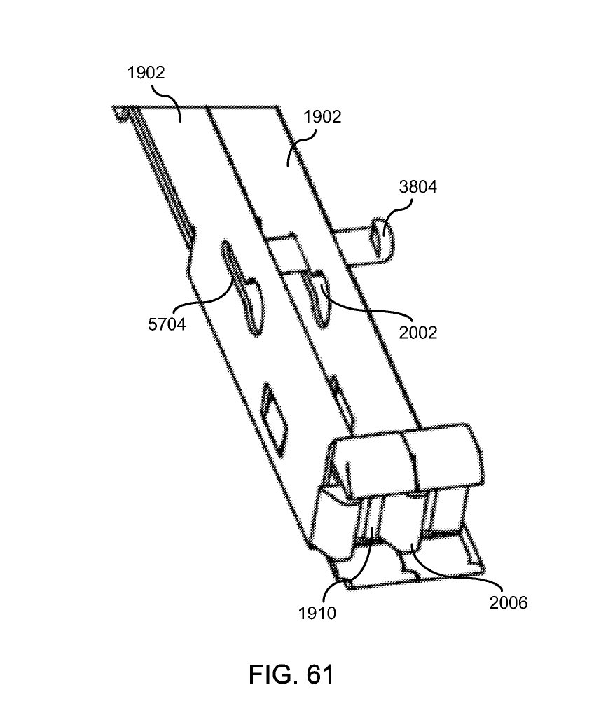

FIGS. 59-62 depict various views of two of the spine elements 1902 in the process (e.g., the next, third or last stage) of being and/or coupled together. To move from the second stage depicted in FIGS. 55-58, to the third stage depicted in FIGS. 59-62, the spine elements 1902 may be longitudinally moved relative to one another such that the spine elements 1902 are no longer offset relative to one another and/or respective ends 5902 and 5904 may be substantially flush with one another, for example.

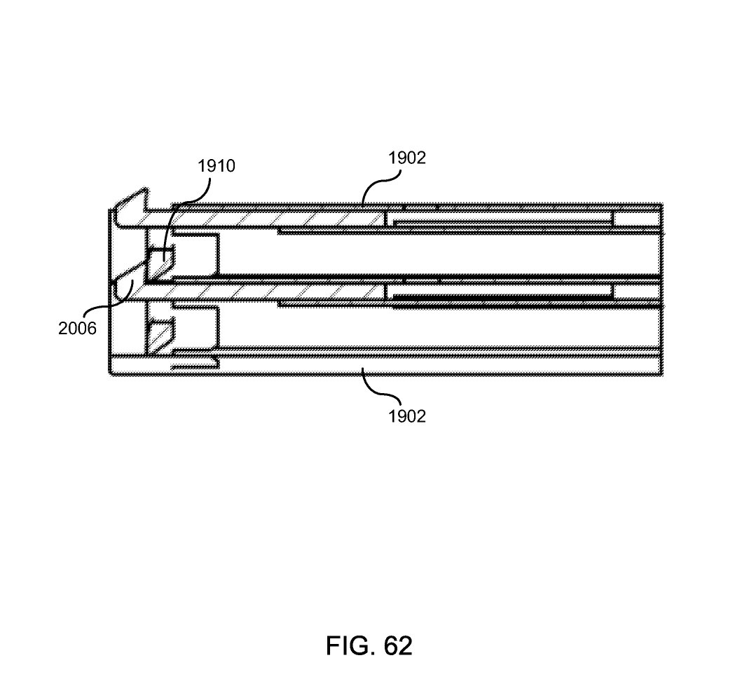

As the spine elements 1902 are moved relative to one another, the head 3804 moves to be substantially within the second portion 5704 of the opening 2002, the locking element 2006 engages and/or is secured via the locking fixture 1910 and the extension 2005 engages the notch 1908. In some examples, in the position depicted in FIGS. 59-62, the pegs 1904 interact with the openings 2002, the ribs 2314 interact with the groove 1906, the locking element 2006 interacts with the locking fixture 1910, the notch 1908 interacts with the extension 2005 and/or the groove and rib 1912 interact with the groove and rib 2008. All or some of these features enable the spine elements 1902 to be coupled and/or relatively stable relative to one another. FIG. 62 depicts a cross-sectional view along Q-Q of FIG. 59.

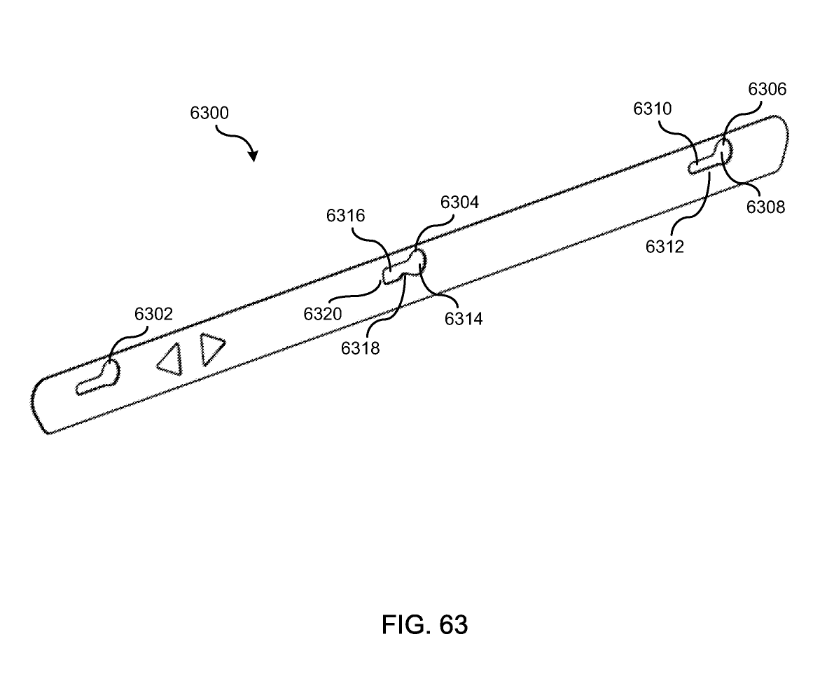

FIG. 63 depicts an example retaining bar 6300 that may be used in connection with the examples described herein. The retaining bar 6300 may be used to secure items or materials relative to the spine elements 1902, for example. In some examples, the retaining bar 6300 may be made of metal, plastic, etc. In some examples, the retaining bar 6300 may be elastically deformable and/or made of an elastic material.

The retaining bar 6300 may define a first aperture 6302, a second aperture 6304 and a third aperture 6306. The first and third apertures 6302 and 6306 may be substantially similar to one another. The second aperture 6304 may be different than the first and third apertures 6302 and 6306.

In some examples, the first and third apertures 6302 and 6306 may include a first portion 6308 and a second portion 6310. The first portion 6308 may be sized to enable the peg 1904 to extend therethrough. The second portion 6310 may be sized such that a surface 6312 adjacent the second portion 6310 interacts with the respective peg 1904 to at least partially secure the retaining bar 6300 relative to the pegs 1904, for example.

In some examples, the second aperture 6304 includes a first portion 6314 and a second portion 6316. A tab or extension 6318 may be positioned between the portions 6314 and 6316, for example. The first portion 6314 may be sized to enable the peg 1904 to extend therethrough. The second portion 6316 may be sized such that a surface 6320 adjacent the second portion 6316 interacts with the respective peg 1904 to at least partially secure the retaining bar 6300 relative to the pegs 1904. The tab 6318 may interact with the peg 1904 to substantially prevent the retaining bar from inadvertently moving between the portions 6314 and 6316, for example. In practice, the pegs 1904 may be positioned such that they extend through the apertures 6302-6306. The retaining bar 6300 may then be moved relative to the pegs 1904 to position the pegs 1904 in the respective second portions 6310, 6316, for example.

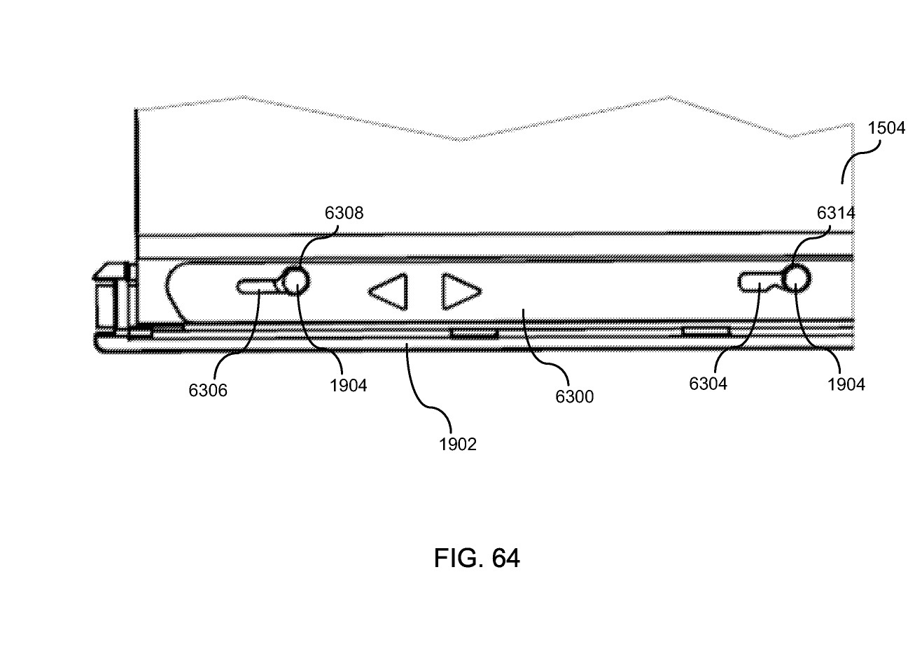

FIG. 64 depicts a partial view of one of the spine elements 1902. The pegs 1904 are extending through one of the sheets 1504 and are positioned in the first portion 6308 and 6314 of the respective apertures 6302, 6306.

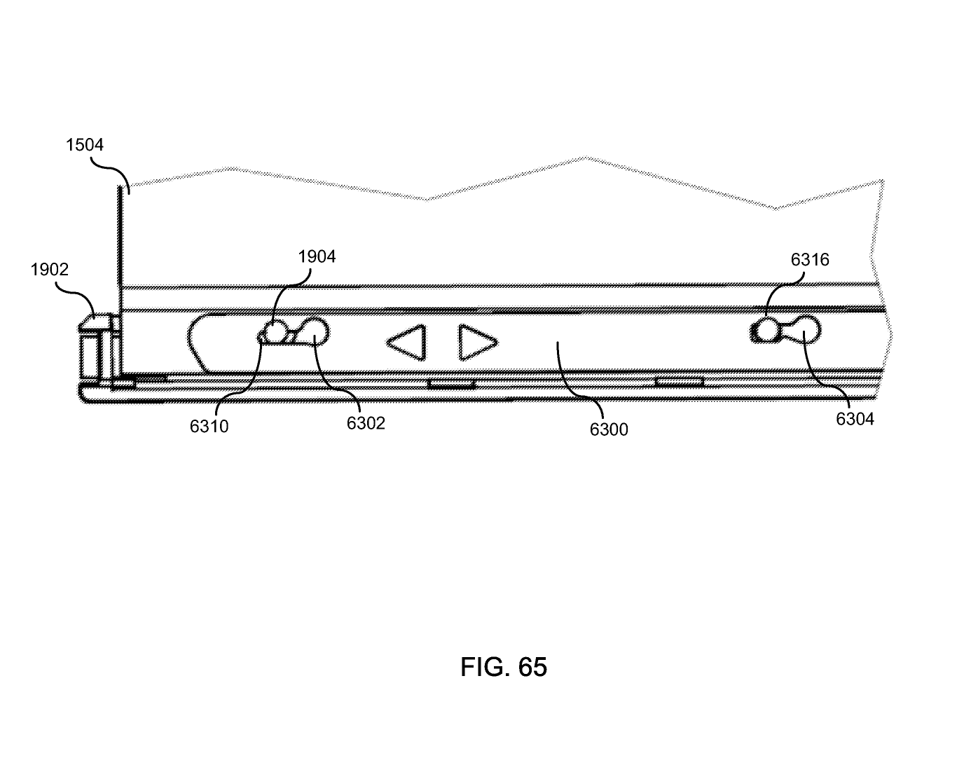

FIG. 65 depicts a partial view of one of the spine elements 1902. The pegs 1904 are extending through one of the sheets 1504 and are positioned in the second portion 6310 and 6316 of the respective apertures 6302, 6304.

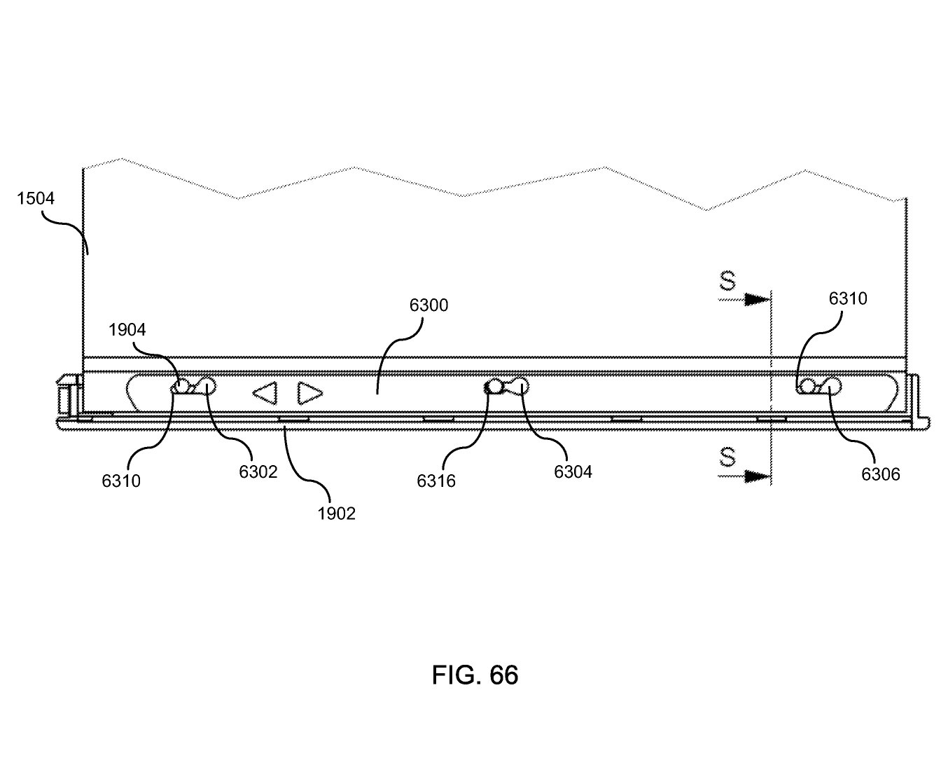

FIG. 66 depicts one of the spine elements 1902. The pegs 1904 are extending through one of the sheets 1504 and are positioned in the second portion 6310 and 6316 of the respective apertures 6302-6306.

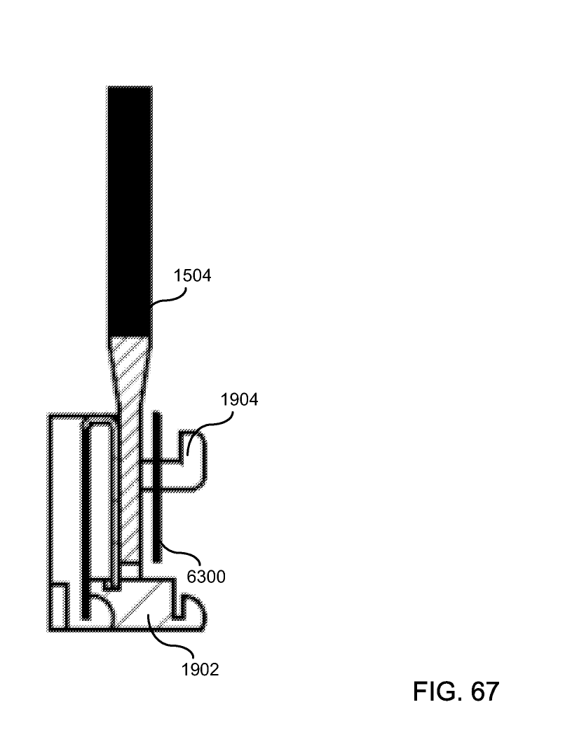

FIG. 67 depicts a cross-sectional view along S-S of FIG. 66 that illustrates the interaction between the retaining bar 6300, one of the pegs 1904, the sheet 1504 and the spine element 1902.

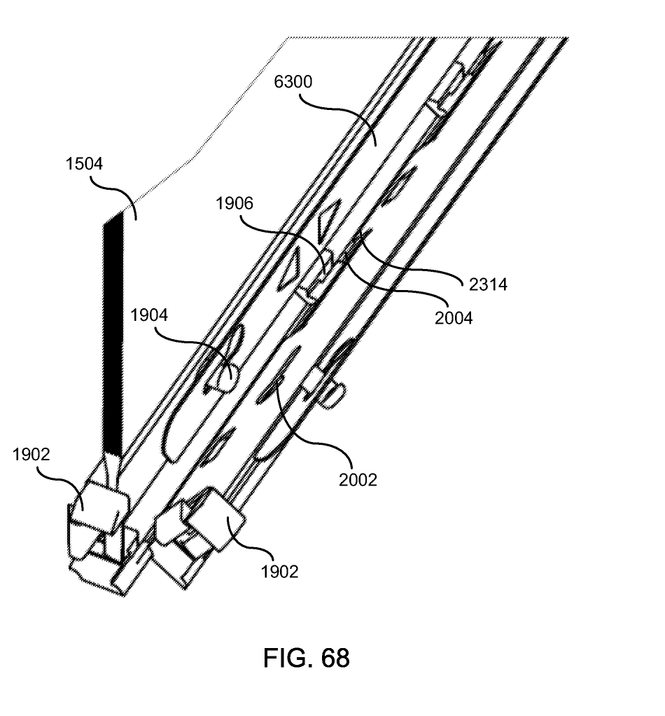

FIG. 68 depicts two of the spine elements 1902 in the process (e.g., the initial or first stage) of being coupled together. The pegs 1904 are extending through one of the sheets 1504 and the respective apertures 6302-6306 of the retaining bar 6300. Once the spine elements 1902 are coupled together, the sheet 1504 will be retained within a gap defined between the adjacent spine elements 1902 and the retaining bar 6300 will substantially prevent the sheet 1504 from being loose within the gap, for example.

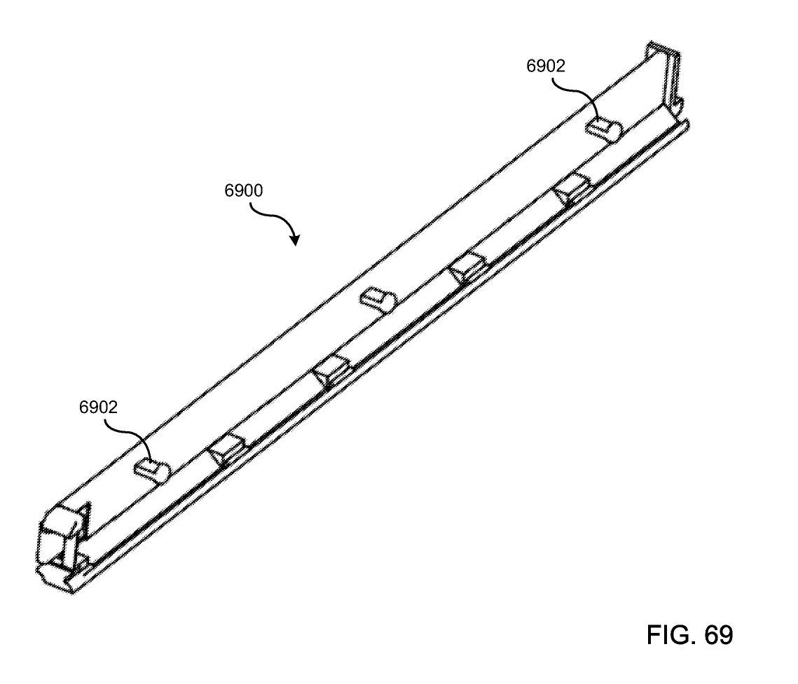

FIG. 69 depicts an example spine element 6900 having example posts, extensions, pins or pegs 6902.

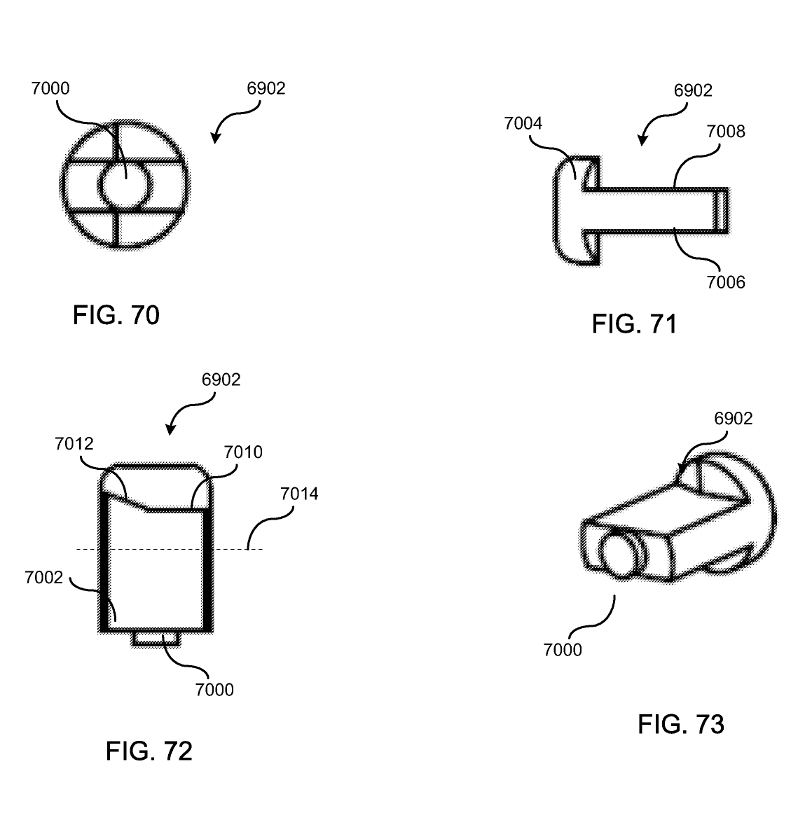

FIGS. 70-73 depict different views of the pegs 6902. In some examples, the peg 6902 includes a portion 7000 that may be positioned in apertures defined by the spine element 6900 to facilitate coupling therewith. In some examples, the peg 6902 may include a body 7002 and a head 7004. The head 7004 may extend substantially perpendicularly from opposing surfaces 7006 and 7008 of the body 7002, for example.

In some examples, the head 7004 includes a first surface 7010 and a second surface 7012. The first surface 7010 may be substantially parallel to a lateral axis 7014 of the peg 6902, for example. The second surface 7012 may be at a substantially non-parallel angle relative to the lateral axis 7014. The angle of the second surface 7012 may facilitate relatively easy interaction and/or locking between the peg 6902 and the opening 2002, for example. The angle of the second surface 7012 may facilitate relatively easy interaction and/or locking between the peg 6902 and the openings of a retaining bar, for example. While a particular angle of the second surface 7012 is depicted, the second surface 7012 may be at any other angle including a substantially parallel angle relative to the lateral axis 7014, for example.

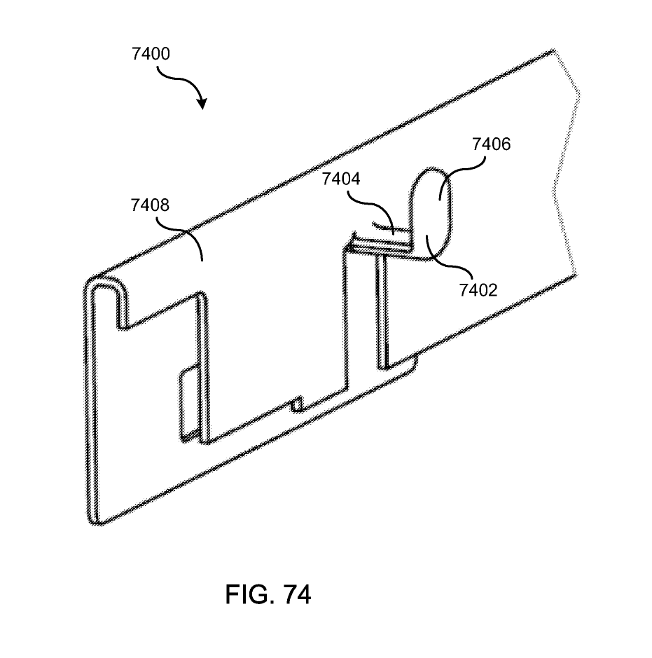

FIG. 74 depicts a partial view of an example second portion 7400 having an example pin 7402 formed from the second portion 7400 itself. In some examples, the pin 7402 includes a first portion 7404 and a second portion 7406. The first portion 1704 may be substantially perpendicular to a surface 7408 and may be substantially perpendicular to the second portion 7406.

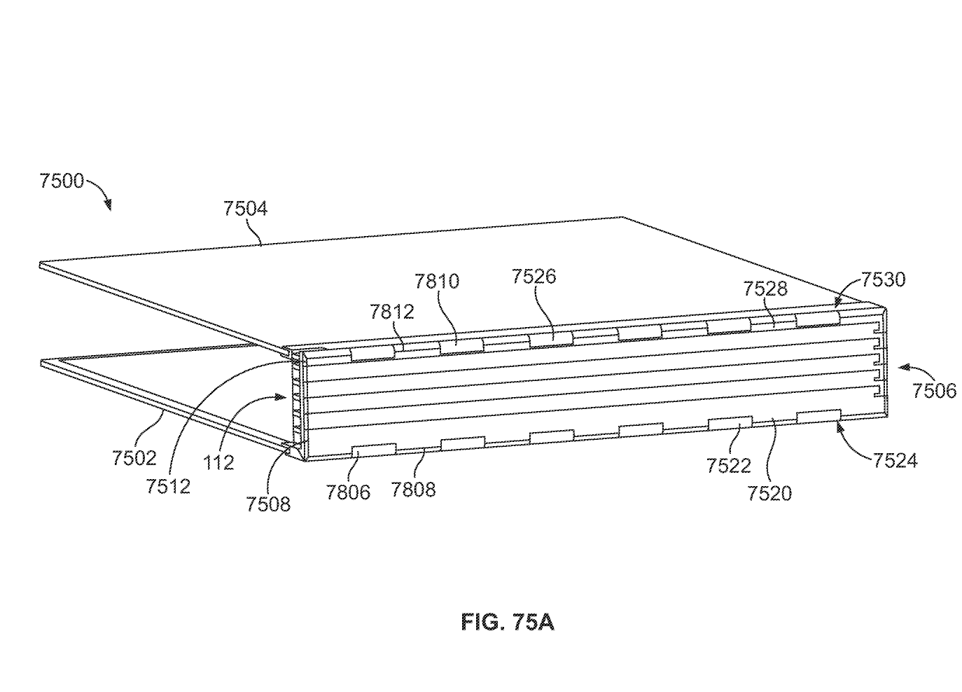

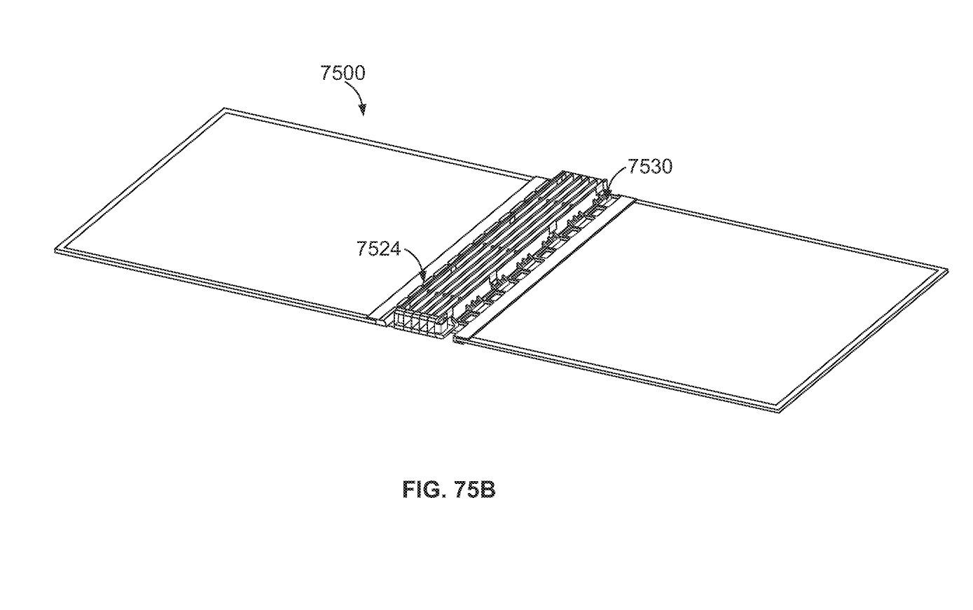

FIGS. 75A and 75B depict an example album or binder 7500 that can be used for storing similar or different items or materials. In some examples, the items or materials include documents, inserts, sleeves, photos, etc. In some examples, the items or materials are similar or different size(s), shape(s), thicknesse(es), etc. The album 7500 includes a first cover 7502, a second cover 7504 and a spine 7506 including spine elements 112, 7508, 7512. The first spine element 7508 includes a first portion 7520 hingably coupled to a second portion 7522 by a first hinge (e.g., a piano hinge) 7524. The second spine element 7512 includes a third portion 7526 hingably coupled to a fourth portion 7528 by a second hinge (e.g., a piano hinge) 7530.

In some examples, the first and second spine elements 7508 and 7512 are detachably or removably coupled to one of the spine elements 112 adjacent thereto. In other examples, the first and second spine elements 7508 and 7512 are detachably or removably coupled to one another such that the spine 7506 is relatively small. The spine elements 112 may be detachably or removably coupled to one of the spine elements 112 adjacent thereto or, depending on the position of the respective spine element 112, to the first spine element 7508 and/or the second spine element 7512.

The size of the spine 7506 may change to accommodate additional or less items or materials by changing the number of the spine elements 112 (e.g., 0, 1, 2, 3, 4, etc.) included in the spine 7506. In some examples, to change the size of the spine 7506, the first spine element 7508 is detached from the spine element 112 adjacent thereto and then one or more of the spine elements 112 are added to or removed from the plurality of spine elements 112. The first spine element 7508 may then be reattached to the adjacent spine element 112 or, if no spine elements 112 are provided, to the second spine element 7512. In some examples, to change the size of the spine 7506, the second spine element 7512 is detached from the spine element 112 adjacent thereto and then one or more of the spine elements 112 are added to or removed from the plurality of spine elements 112. The second spine element 7512 may then be reattached to the adjacent spine element 112 or, if no spine elements 112 are provided, to the first spine element 7508.

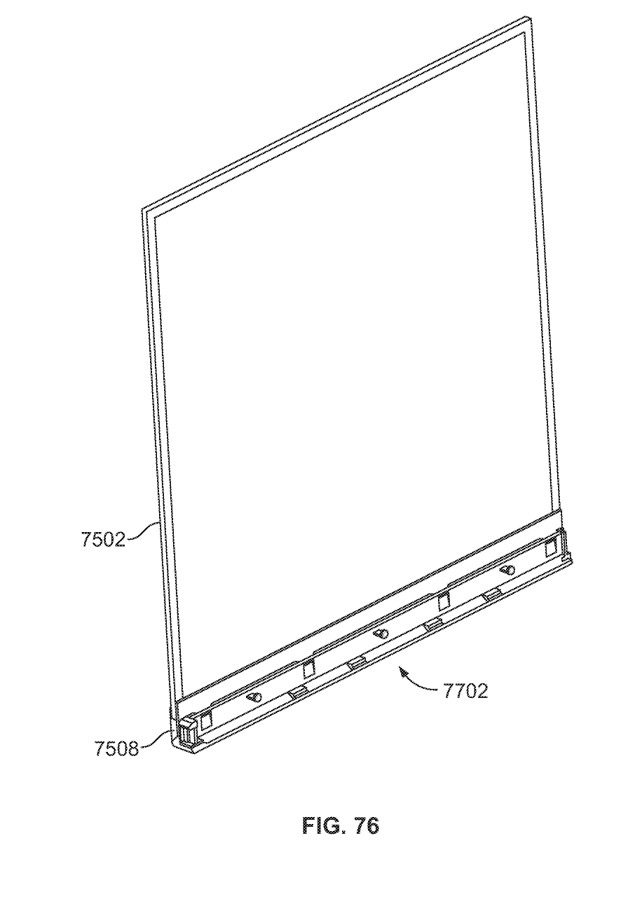

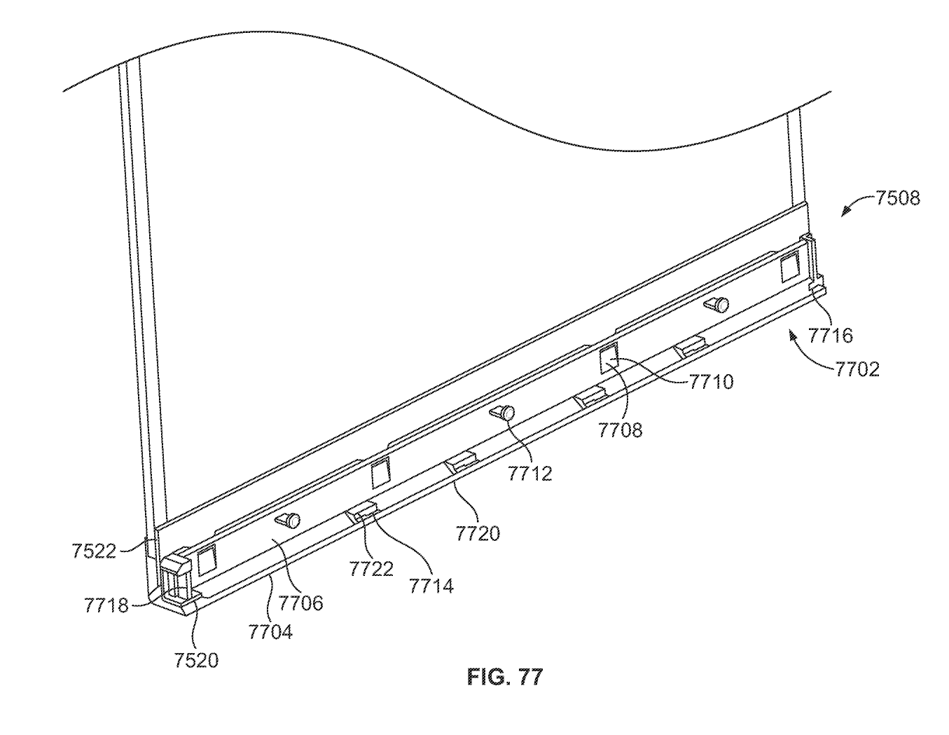

FIGS. 76 and 77 depict a first side 7702 of the first spine element 7508 where the first spine element 7508 is coupled to the first cover 7502. As shown in FIG. 77, in the illustrated example, the first spine element 7508 includes a first elongated and/or plastic portion 7704 and a second elongated and/or metal portion 7706. In some examples, the plastic portion 7704 is coupled to the metal portion 7706 by pre-tensioning the metal portion 7706 prior to coupling with the plastic portion 7704. In some examples, to couple the plastic portion 7704 to the metal portion 7706, tabs 7708 of the metal portion 7706 interact with and/or are received by openings 7710 defined by the second portion 7706. While the portion 7704 is described as being plastic and the portion 7706 is described as being metal, the portions 7704, 7706 may be made of any other material(s).

The first spine element 7508 may include one or more features that enable coupling with and/or stability relative to the adjacent spine element 112 and/or the second spine element 7512. In some examples, the first side 7702 includes a plurality of pegs 7712 and/or a plurality of groove(s) or slot(s) 7714. In some examples, the first side 7702 includes a notch 7716, a locking fixture 7718 and/or a groove and rib 7720. In some examples, the first side 7702 includes a structure or block 7722 adjacent the groove 7714. The pegs 7712, the groove 7714, the notch 7716, the locking fixture 7718, the groove and rib 7720 and/or the structure 7722 of the first side 7702 may interact with corresponding surfaces or structures of the adjacent spine element 112 and/or the second spine element 7512 to couple the spine elements 112, 7508 and/or 7512 together.

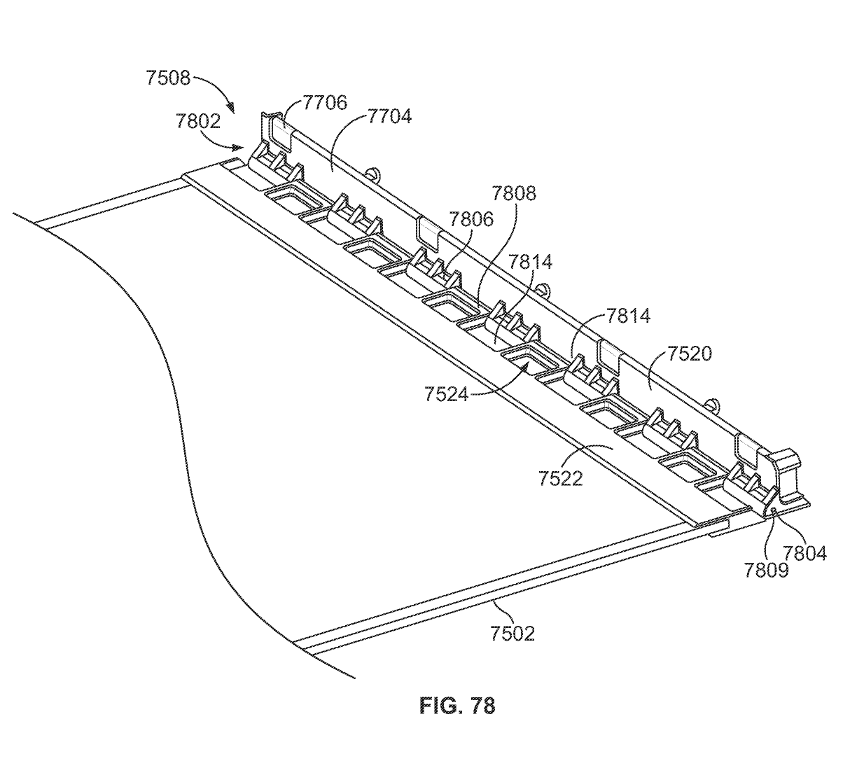

FIG. 78 depicts a second side 7802 of the first spine element 7508 and the hinge 7524 coupling the portions 7520, 7522. In this example, the hinge 7524 includes a pin 7804, a plurality of first knuckles 7806 and a plurality of second knuckles 7808. The first knuckles 7806 are part of the first portion 7520 and the second knuckles 7808 are part of the second portion 7522. In other examples, the first and second knuckles 7806, 7808 are coupled to the respective portions 7520, 7522 by fasteners, plastic welding, glue, etc. The first and second knuckles 7806 and 7808 are positioned in an alternating pattern along a length of the first spine element 7508. The knuckles 7806, 7808 have aligned apertures 7809 through which the pin 7804 extends to couple the portions 7520, 7522.

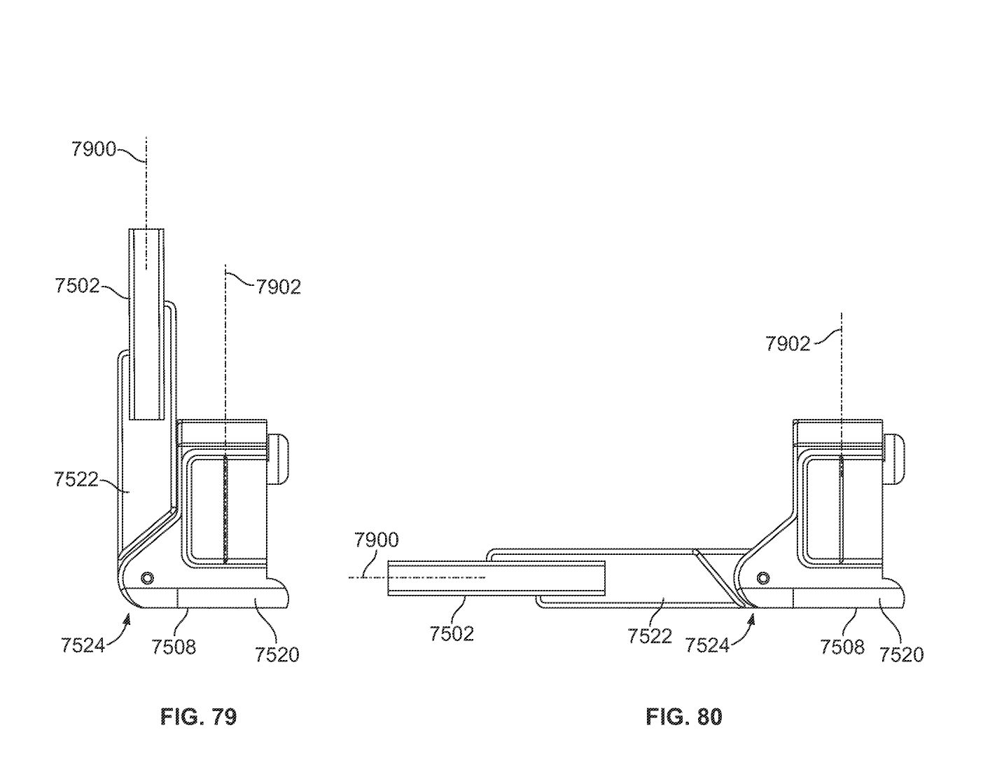

In operation, as the portions 7520, 7522 rotate relative to one another, the respective knuckles 7806, 7808 are received in grooves and/or cavities 7814 of the opposing portions 7520, 7522. Having the knuckles 7806 and/or 7808 be at least partially positioned in the adjacent cavities 7814 enables axes 7900, 7902 (FIG. 79) of the portions 7520, 7522 to be substantially parallel to one another. As used herein, the phrase “substantially parallel” means less than 10-degrees of parallel.

FIG. 79 depicts a side view of the first spine element 7508 and the first cover 7502 in closed position such that the axes 7900, 7902 are substantially parallel to one another. FIG. 80 depicts a side view of the first spine element 7508 and the first cover 7502 in the open position such that the axes 7900, 7902 are substantially perpendicular to one another. As used herein, the phrase “substantially perpendicular” means less than 10-degrees of perpendicular.

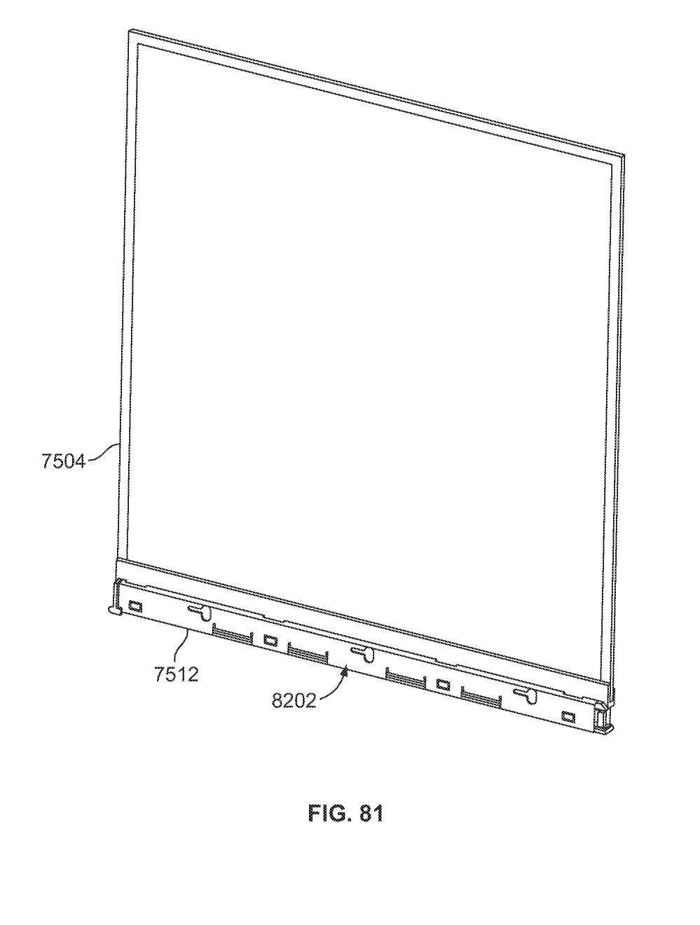

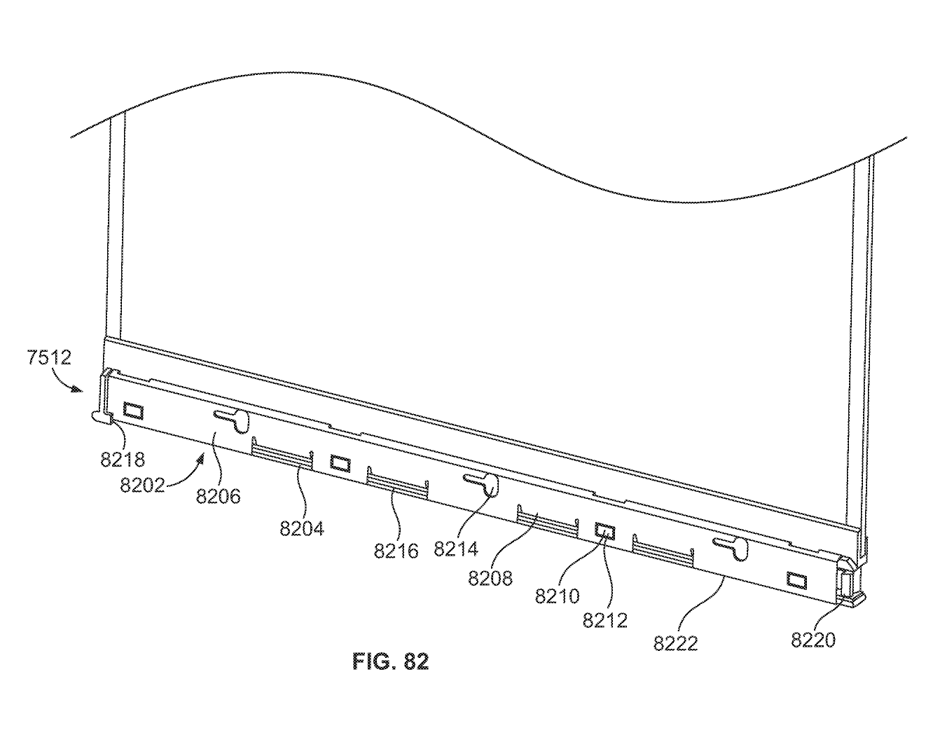

FIGS. 81 and 82 depict a first side 8202 of the second spine element 7512. As shown in the illustrated example of FIG. 82, the second spine element 7512 includes a third elongated and/or plastic portion 8204 and a fourth elongated and/or metal portion 8206. In some examples, the plastic portion 8204 may be coupled to the metal portion 8206 by pre-tensioning the metal portion 8206 prior to coupling with the plastic portion 8204. In some examples, to couple the plastic portion 8204 and the metal portion 8206, tabs 8208 of the metal portion 8206 interact with and/or are received in portions of the plastic portion 8204 and/or tabs 8210 of the metal portion 8206 interact with and/or are received by openings 8212 defined by the metal portion 8206. While the portion 8204 is described as being plastic and the portion 8206 is described as being metal, the portions 8204, 8206 may be made of any other material(s).

The first side 8202 of the second spine element 7512 may include one or more features that enable coupling with and/or stability relative to the adjacent spine element 112 and/or the first spine element 7508. In some examples, the first side 8202 includes a plurality of first openings 8214 and/or a plurality of second openings 8216. In some examples, the first side 8202 includes an extension 8218, a biasing or locking element 8220 and/or a groove and rib 8222. The first openings 8214, the second openings 8216, the extension 8218, the locking element 8220 and/or the groove and rib 8222 of the first side 8202 of the second spine element 7512 may interact with corresponding surfaces or structures of the adjacent spine element 112 and/or the first spine element 7508, for example.

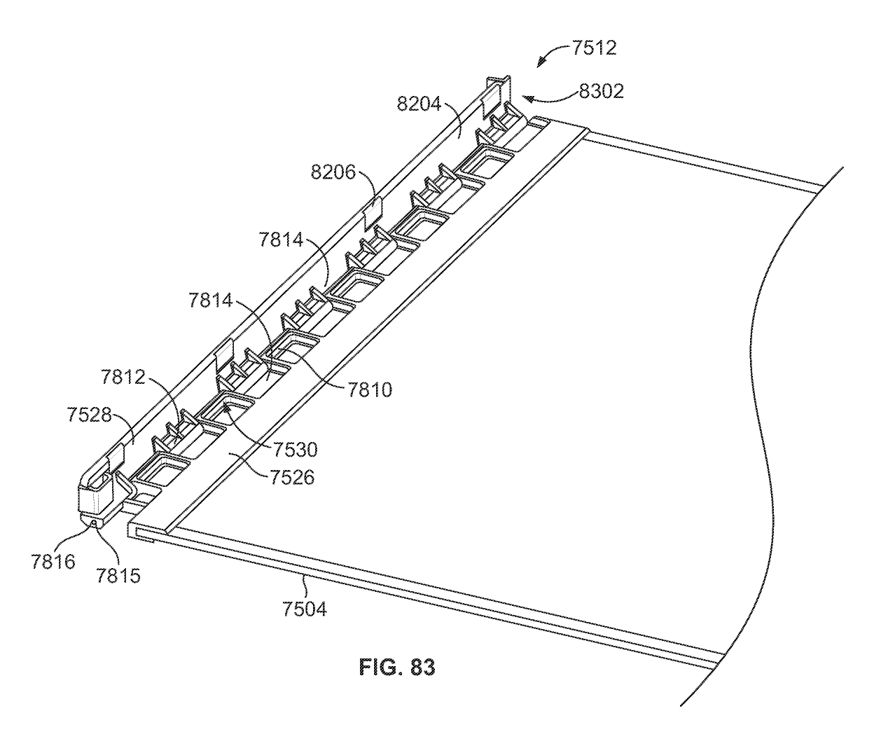

FIG. 83 depicts a second side 8302 of the second spine element 7512 and the hinge 7530 coupling the portions 7526, 7528. In this example, the hinge 7530 includes a pin 7816, a plurality of third knuckles 7810 and a plurality of forth knuckles 7812. The third knuckles 7810 are part of the third portion 7526 and the fourth knuckles 7812 are part of the fourth portion 7528. In other examples, the third and fourth knuckles 7810, 7812 are coupled to the respective portions 7526, 7528 by fasteners, plastic welding, glue, etc. The third and fourth knuckles 7810, 7812 are positioned in an alternating pattern along a length of the second spine element 7512. The knuckles 7810, 7812 have aligned apertures 7815 through which the pin 7816 extends to couple the portions 7526, 7528.

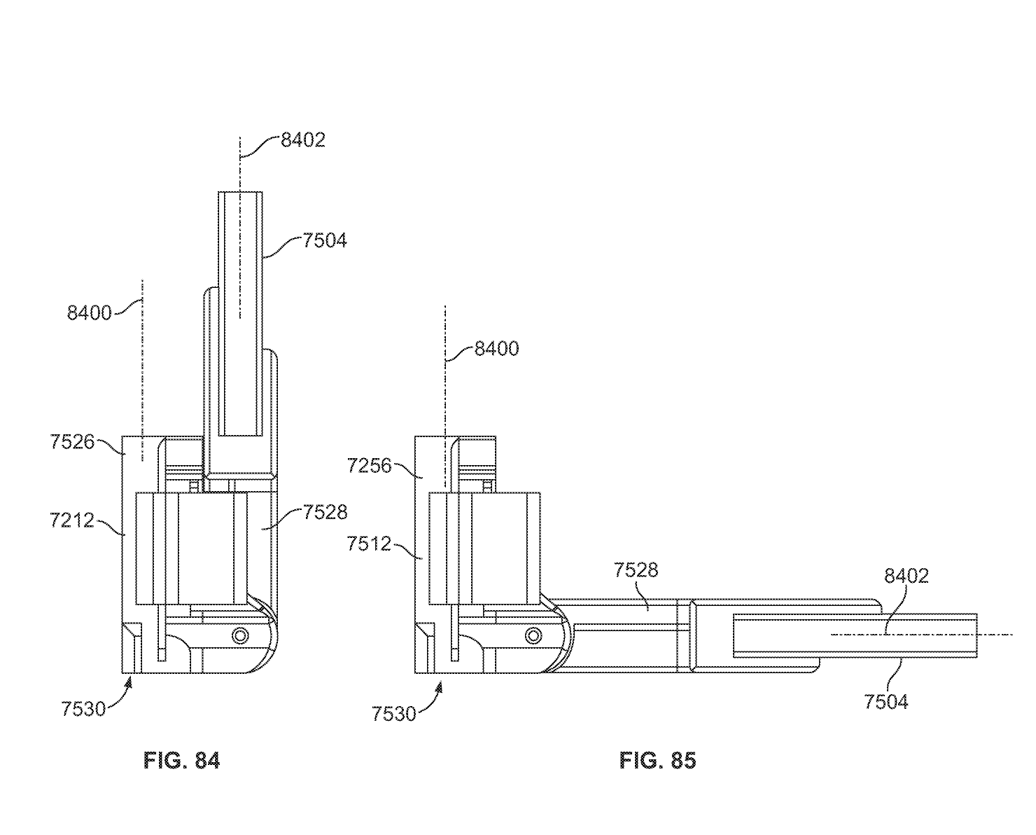

FIG. 84 depicts a side view of the second spine element 7512 in a closed position such that axes 8400, 8402 of the portions 7256, 7528 are positioned substantially parallel to one another. FIG. 85 depicts a side view of the second spine element 7512 in an open position such that the axes 8400, 8402 of the portions 7256, 7528 are positioned substantially perpendicular relative to one another.

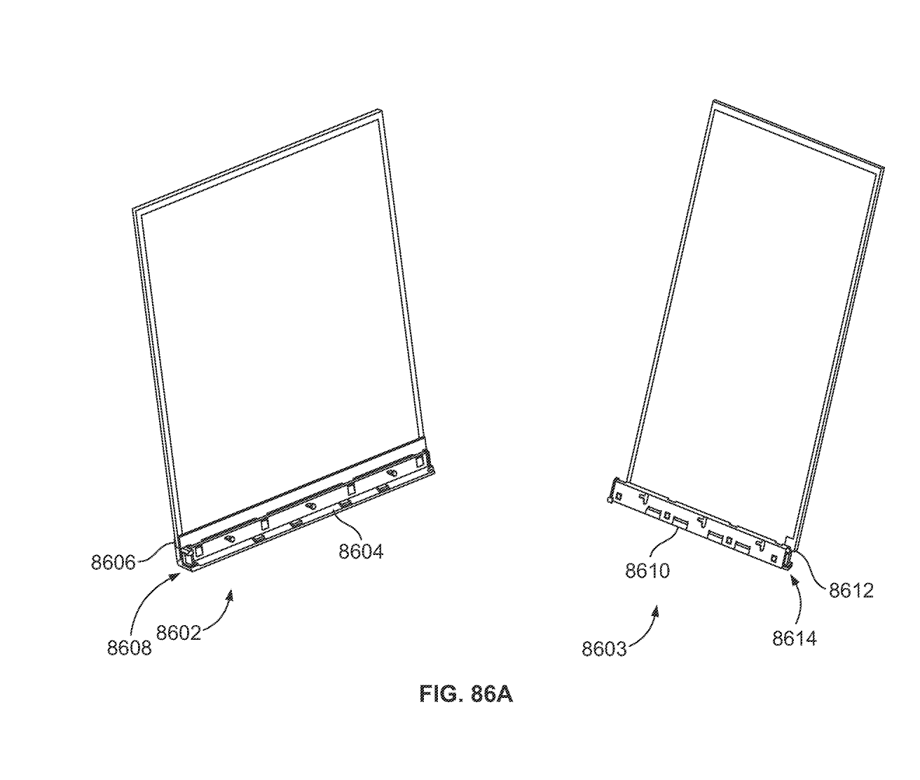

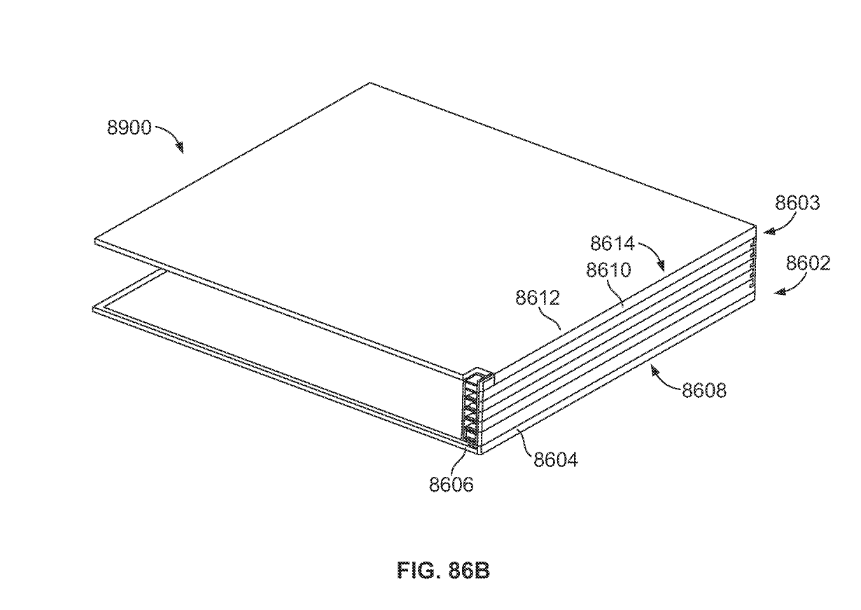

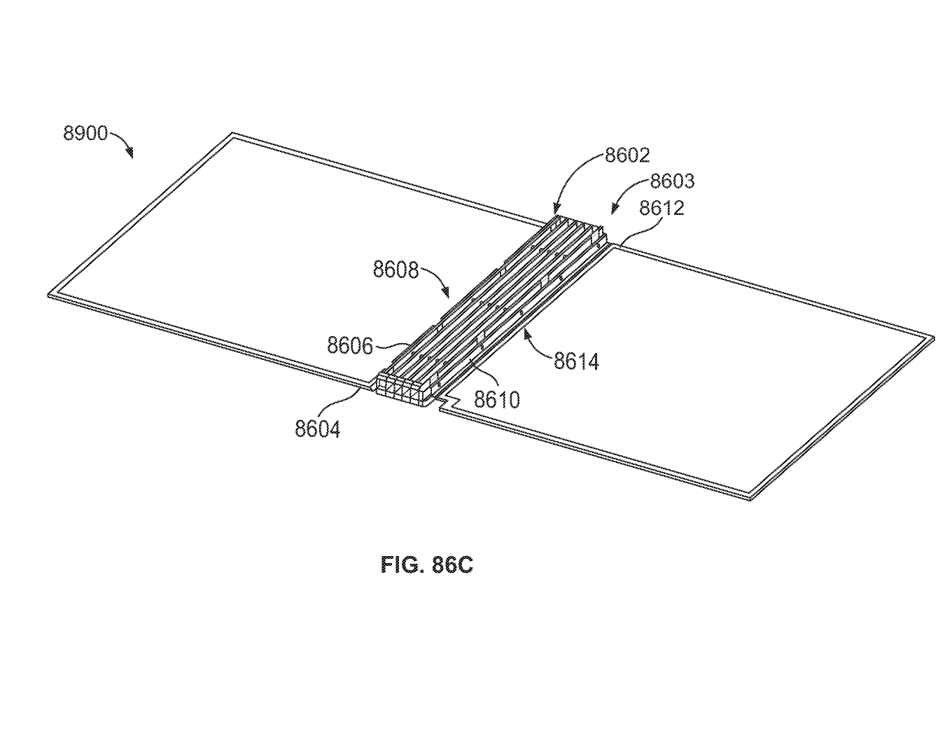

FIGS. 86A-95 depict an example binder 8900 and example first and second spine elements 8602, 8603 that can be used in combination with and/or in place of the spine elements 7508, 7510 described above. As shown in FIGS. 86A-86C, in contrast to the examples described above, the first spine element 8602 includes a first portion 8604 hingably coupled to a second portion 8606 by a first hinge (e.g., a living hinge) 8608 and the second spine element 8603 includes a third portion 8610 hingably coupled to a fourth portion 8612 by a second hinge (e.g., a living hinge) 8614. FIG. 86B depicts the binder 8900 in a closed position, and FIG. 86C depicts the binder 8900 in an open position.

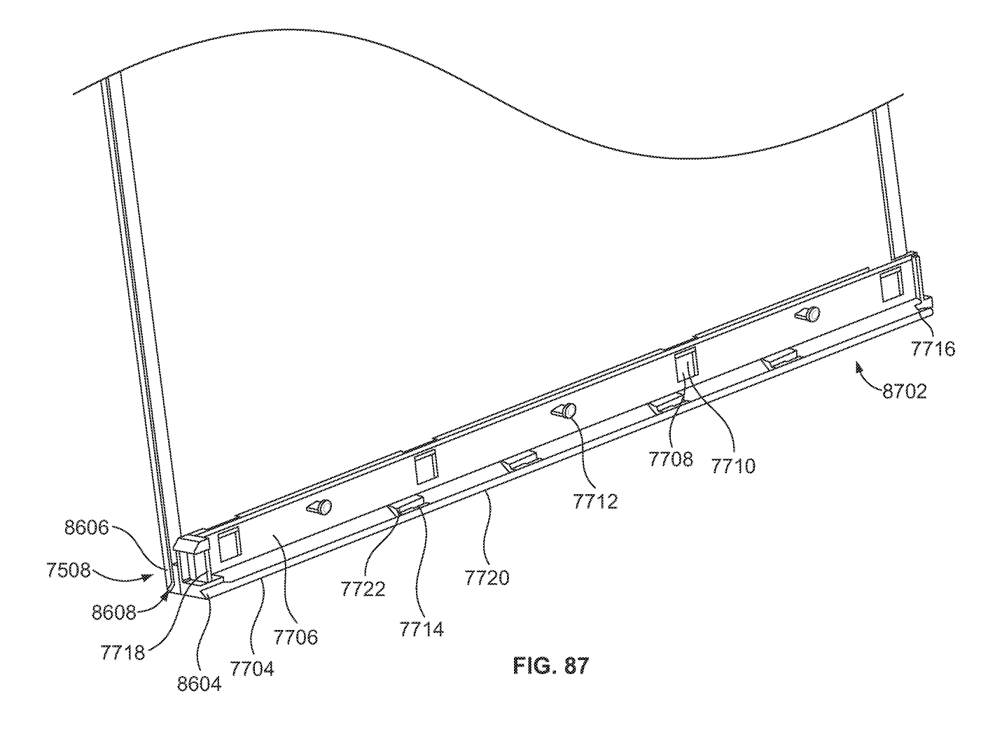

FIG. 87 depicts the first side 8702 of the first spine element 8602 as the first cover 7502 is in the closed position. Because the first side 8702 of FIG. 87 is similar to the first side 7702 of FIG. 77, like or identical reference numbers are used to identify the common or similar elements.

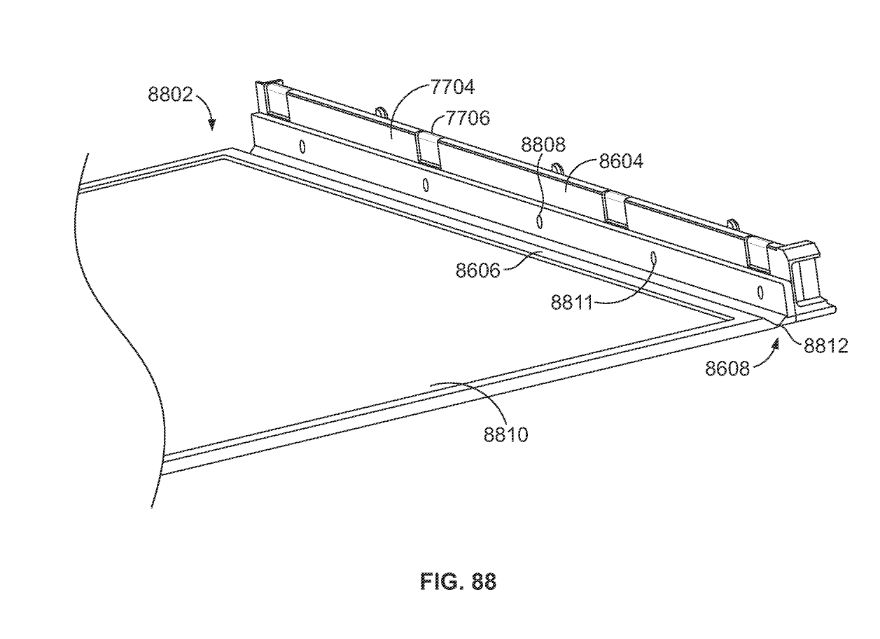

FIG. 88 depicts a second side 8802 of the first spine element 8602 and the hinge 8608 coupling the portions 8604, 8606. As shown in the illustrated example of FIG. 88, the portion 8606, the hinge 8608 and a first cover 8810 are a single piece of material. However, in other examples, the first cover 8810 is made of a different material than the portions 8604, 8606 and/or the hinge 8608.

As shown in FIG. 88, the hinge 8606 may be coupled to the plastic portion 7704 by a plurality of fasteners 8808 that extend through apertures 8811. In other examples, the hinge 8608 may be formed with the plastic portion 7704. In some examples, the hinge 8608 enables the first cover 8802 to rotate about the hinge 8608 relative to the first portion 8604. In some examples, the hinge 8608 is an indentation, groove, etc. 8812 formed from the same piece of material as the first and/or second portions 8604, 8606.

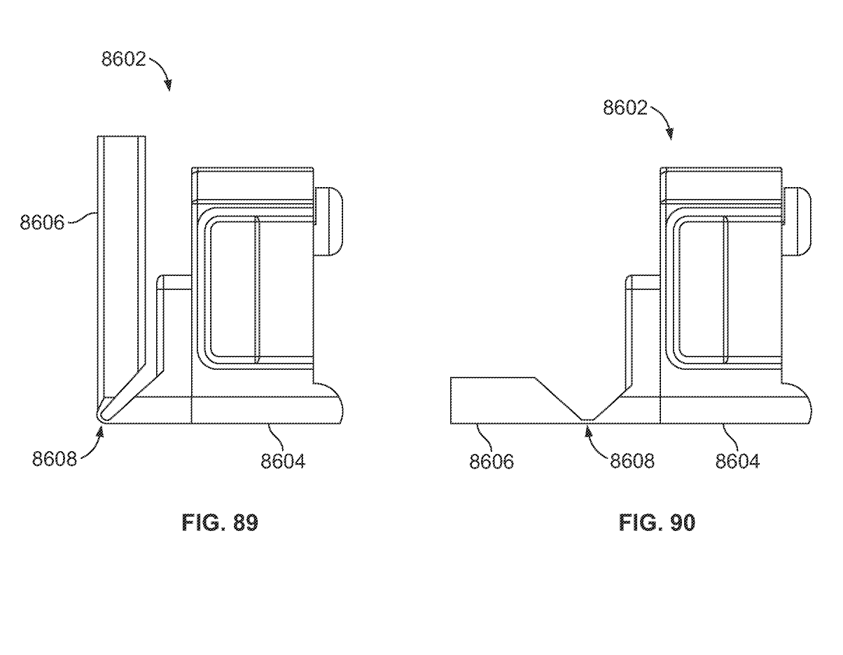

FIG. 89 depicts a side view of the first spine element 8602 in the closed position and FIG. 90 depicts a side view of the first spine element 8602 in the open position.

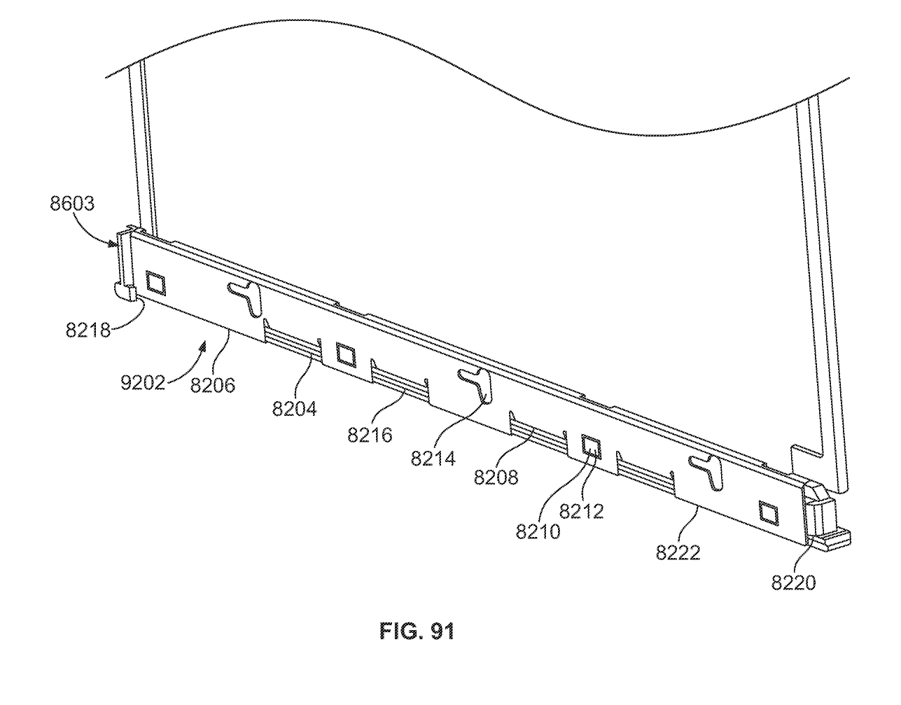

FIG. 91 depicts a first side 9202 of the second spine element 8603 and a second cover 9304 in the closed position. Because the first side 9202 of FIG. 91 is similar to the first side 8202 of FIG. 82, like or identical reference numbers are used to identify the common or similar elements.

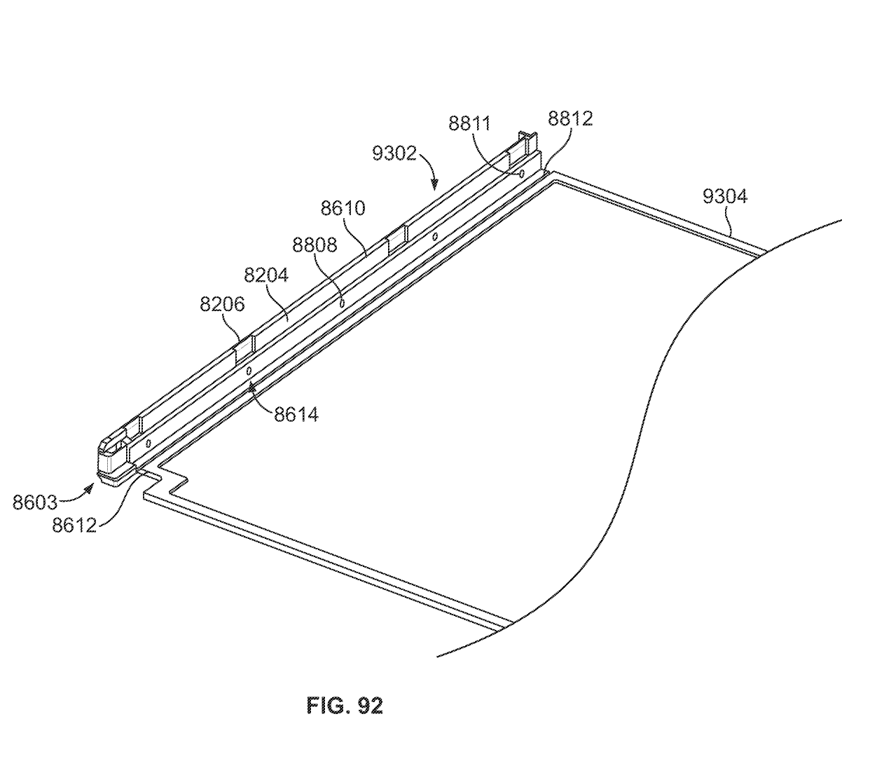

FIG. 92 depicts a second side 9302 of the second spine element 8603 coupled to the second cover 9304. Because the second side 9302 of the second spine element 8603 is similar to the second side 7802 of the first spine element 8602 of FIG. 88, like or identical reference numbers are used to identify the common or similar elements.

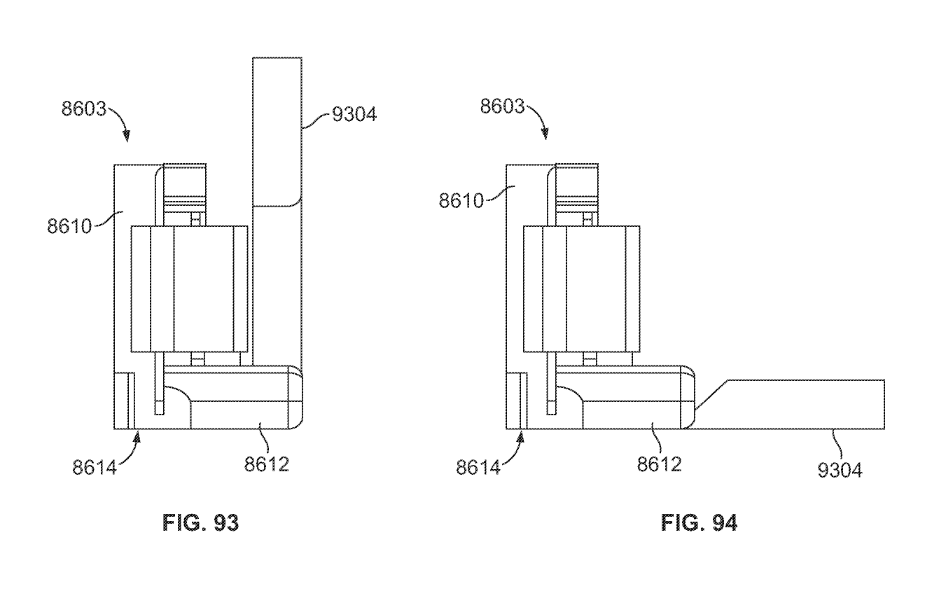

FIG. 93 depicts a side view of the second spine element 8603 in the closed position and FIG. 94 depicts a side view of the second spine element 8603 in the open position.

Furthermore, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalent.

What is claimed is:

1. A spine element for use in a variable width album, the spine element comprising:
a first side and a second side, the first side comprising a plurality of extensions extending therefrom, each of the plurality of extensions comprising an end and an elongated portion, the end having a larger width than the elongated portion, each end to be received by a first portion of an opening of an adjacent spine element, each elongated portion to be received by a second portion of the opening of the adjacent spine element after the extensions are received by the openings of the adjacent spine element and the adjacent spine element is longitudinally moved relative to the spine element to couple the spine elements together; and
a cover coupled to the second side.

2. The spine element of claim 1, wherein the cover comprises a living hinge.

3. The spine element of claim 1, wherein the cover is hingably coupled to the second side.

4. The spine element of claim 1, wherein the spine element comprises a first portion and a second portion, the first portion comprises the first side, the second portion comprises the second side, the first portion hingably coupled to the second portion.

5. The spine element of claim 4, wherein the first portion is hingably coupled to the second portion by a piano hinge.

6. The spine element of claim 4, wherein the first portion is hingably coupled to the second portion by a living hinge.

7. A spine element for use in a variable width album, the spine element comprising:
a first side and a second side, the first side comprising a plurality of openings, each of the openings comprising a first portion sized to receive an end of an extension of an adjacent spine element and a second portion sized to receive an elongated portion of the extension of the adjacent spine element when the extensions of the adjacent spine element are received by the openings of the spine element and the adjacent spine element is longitudinally moved relative to the spine element to couple the spine elements together; and
a cover coupled to the second side.

8. The spine element of claim 8, wherein the cover comprises a living hinge.

9. The spine element of claim 8, wherein the cover is hingably coupled to the second side.

10. The spine element of claim 8, wherein the spine element comprises a first portion and a second portion, the first portion comprises the first side, the second portion comprises the second side, the first portion hingably coupled to the second portion.

11. The spine element of claim 11, wherein the first portion is hingably coupled to the second portion by a piano hinge.

12. The spine element of claim 11, wherein the first portion is hingably coupled to the second portion by a living hinge.

13. A variable width album, comprising:
a first cover;
a second cover;
a first spine element comprising a first side and a second side, the first side comprising a plurality of first extensions, a first rib, and a first groove, the second side being coupled to the first cover; and
a second spine element comprising a third side and a fourth side, the third side comprising a plurality of third openings, a third rib, and a third groove, the fourth side being coupled to the second cover, wherein to couple the first spine element to the second spine element, the first rib is received by the third groove, the third rib is received by the first groove and, as the spine elements are longitudinally moved relative to one another, the first extensions are received within a portion of the respective third openings.

14. The spine element of claim 13, wherein the first cover is hingably coupled to the second side.

15. The spine element of claim 1, wherein the first spine element comprises a first portion and a second portion, the first portion comprises the first side, the second portion comprises the second side, the first portion hingably coupled to the second portion.

16. The spine element of claim 15, wherein the first portion is hingably coupled to the second portion by a piano hinge.

17. The spine element of claim 15, wherein the first portion is hingably coupled to the second portion by a living hinge.

18. The spine element of claim 13, wherein the second spine element comprises a first portion and a second portion, the first portion comprises the third side, the second portion comprises the forth side, the first portion hingably coupled to the second portion.

19. The spine element of claim 19, wherein the first portion is hingably coupled to the second portion by a piano hinge.

20. The spine element of claim 19, wherein the first portion is hingably coupled to the second portion by a living hinge.
